(19) United States
(12) Patent Application Publication
(10) Pub. No.: US 2020/0134947 A1
(43) Pub. Date: Apr. 30, 2020

(54) SECURITY SYSTEM WITH PERSON OF INTEREST USER INTERFACE NOTIFICATIONS

(71) Applicant: Johnson Controls Technology Company, Auburn Hills, MI (US)

(72) Inventors: Maebh Costello, Cork (IE); Jan R. Holliday, Maryville, IL (US); Frederico Fala, Cobh (IE); Nicolae Bogdan PAVEL, Cork (IE)

(21) Appl. No.: 16/666,042

(22) Filed: Oct. 28, 2019

Related U.S. Application Data
(60) Provisional application No. 62/751,856, filed on Oct. 29, 2018.
(60) Provisional application No. 62/751,898, filed on Oct. 29, 2018.

(51) Int. Cl. G07C 9/00; G08B 13/24; G06K 9/00; G06F 16/21

(52) U.S. Cl. CPC G07C 9/00158; G08B 13/24; H04L 51/22; G06K 9/00671; G06F 16/21; G06K 9/00288

(57) ABSTRACT

A method for a person of interest (POI) monitoring system including generating a POI data structure, wherein the POI data structure includes an identifier of an individual to be monitored as a POI, causing the POI data structure to include an indication of one or more recipients to be notified upon detection of the individual, receive, from a security device, security data that describes an interaction of the individual with the security device, the security data including the identifier of the individual, determining whether the received identifier matches the identifier of the POI data structure, and causing one or more user devices associated with the one or more recipients to display a GUI notification in response to the received identifier matching the identifier of the POI data structure.

### CROSS REFERENCE TO RELATED APPLICATIONS

The present application claims the benefit and priority to U.S. Provisional Patent Application No. 62/751,856 filed on Oct. 29, 2018, and U.S. Provisional Patent Application No. 62/751,898 filed on Oct. 29, 2018, the entire disclosures of which are incorporated by reference herein.

### BACKGROUND

The present disclosure relates generally to security systems. The present disclosure relates more particularly to user interface notifications associated with security systems.

A security operator may operate a system to manage a number of secure locations. The system may include a large number of secure locations. Each of the number of secure locations may have a different response procedure in the event of a security alarm. As the number of secure locations increases, detecting security alarms and managing a variety of response procedures becomes difficult.

A security notification is one method to standardize a number of response procedures across secure locations. However, a security notification is traditionally generic across different types of security alarms and lacks contextualized information regarding the alarm.

### SUMMARY

One implementation of the present disclosure is a method for a person of interest (POI) monitoring system including generating a POI data structure, wherein the POI data structure includes an identifier of an individual to be monitored as a POI, causing the POI data structure to include an indication of one or more recipients to be notified upon detection of the individual, receive, from a security device, security data that describes an interaction of the individual with the security device, the security data including the identifier of the individual, determining whether the received identifier matches the identifier of the POI data structure, and causing one or more user devices associated with the one or more recipients to display a GUI notification in response to the received identifier matching the identifier of the POI data structure.

In some embodiments, generating the POI data structure further includes receiving, from a setup device, the POI data structure, generating a POI identifier for the POI data structure, receiving, from the setup device, POI information, POI tags, and POI restrictions, and storing the POI data structure with the POI identifier, the POI information, the POI tags, and the POI restrictions. In some embodiments, determining whether the received identifier matches the identifier of the POI data structure further includes receiving, from the security device, a location and an identifier associated with a monitored individual, searching a number of POI data structures with the identifier of the monitored individual, verifying, based on the search, whether the monitored individual is a POI, and determining, based on the location associated with the monitored individual, whether a POI alarm exists. In some embodiments, each of the number of POI data structures further includes one or more restricted areas and wherein the location is associated with the one or more restricted areas. In some embodiments, the security data further includes facial recognition data. In some embodiments, the security data further includes license plate recognition data. In some embodiments, the GUI notification is an email message. In some embodiments, the GUI notification is an alarm in an alarm interface. In some embodiments, the POI data structure further includes a response procedure describing one or more actions for the one or more recipients to take upon receiving the GUI notification. In some embodiments, the security device is an access control device, and wherein the interaction of the individual with the security device includes the individual presenting an identifier (ID) card to the access control device.

A person of interest (POI) monitoring system including a POI database storing a number of POI identifiers, each associated with an individual, wherein each of the POI identifiers is associated with one or more recipients to be notified upon detection of the individual, a processing circuit having at least one processor and memory, the memory storing instructions thereon, that when executed by the at least one processor, cause the processing circuit to receive, from a security device, security data that describes an interaction of a monitored person with the security device, the security data including an identifier associated with the monitored person, determine whether the received identifier matches any of the number of POI identifiers, and in response to determining a match, cause one or more user devices associated with the one or more recipients associated with the matching POI identifier to display a GUI notification.

In some embodiments, the POI database is configured to receive, from a setup device, a POI data structure, generate, a new POI identifier for the POI data structure, receive, from the setup device, POI information, POI tags, and POI restrictions, and store the POI data structure with the POI identifier, POI information, POI tags, and POI restrictions. In some embodiments, the memory further having instructions stored thereon, that when executed by the at least one processor cause, the processing circuit to receive, from the security device, a location associated with the monitored person, and verify, based on the location, that a POI alarm exists. In some embodiments, each of the POI identifiers in the POI database are further associated with one or more restricted areas, and wherein the location is associated with the one or more restricted areas. In some embodiments, the security data further includes facial recognition data. In some embodiments, the security data further includes license plate recognition data. In some embodiments, the GUI notification is an email message. In some embodiments, the GUI notification is an alarm in an alarm interface. In some embodiments, each of the number of POI identifiers in the POI database are further associated with a response procedure describing one or more actions for the one or more recipients to take upon receiving the GUI notification. In some embodiments, the security device is an access control device, and wherein the interaction of the monitored person with the security device includes the monitored person presenting an identifier (ID) card to the access control device.

### BRIEF DESCRIPTION OF THE DRAWINGS

Various objects, aspects, features, and advantages of the disclosure will become more apparent and better understood by referring to the detailed description taken in conjunction with the accompanying drawings, in which like reference characters identify corresponding elements throughout. In the drawings, like reference numbers generally indicate identical, functionally similar, and/or structurally similar elements.

FIG. 1 is a schematic perspective view drawing of a building with a security camera system and a parking lot, according to an exemplary embodiment.

FIG. 2 is a general block diagram of a security monitoring system that can be configured to generate a point of interest (POI) graphical user interface (GUI) notification, according to an exemplary embodiment.

FIG. 3 is a flow diagram of a process that can be implemented by the system of FIG. 2, for setting up POI notifications by storing a POI datablock containing information received from a setup device in the POI system, according to an exemplary embodiment.

FIG. 4 is a flow diagram of a process for identification of a POI alarm by the system of FIG. 2 implementing the POI GUI notification, according to an exemplary embodiment.

FIG. 5 is a flow diagram of a process to report a POI alarm by the system of FIG. 2 generating the POI GUI notification, according to an exemplary embodiment.

FIG. 6 is a schematic drawing of a user interface including a notification sent to a security person concerning a POI alarm that is generated by the system of FIG. 2, according to an exemplary embodiment.

FIG. 7 is a schematic drawing of a portion of the user interface of FIG. 6 including a summary card, which summarizes the identity and location of a POI, according to an exemplary embodiment.

FIG. 8 is a schematic drawing of a portion of the user interface of FIG. 6, including a details card, which provides descriptive information relating to a POI, according to an exemplary embodiment.

FIG. 9 is a schematic drawing of a portion of the user interface of FIG. 6, including an appearance card, which provides physical descriptions of a POI, according to an exemplary embodiment.

FIG. 10 is a schematic drawing of a portion of the user interface of FIG. 6, including a vehicle subsection and an activity traced subsection of the details card of FIG. 8, according to an exemplary embodiment.

FIG. 11 is a schematic drawing of a portion of the user interface of FIG. 6, including a case management card, which provides a summary of the POI case, according to an exemplary embodiment.

FIG. 12 is a schematic drawing of a portion of the user interface of FIG. 6, including a notification text, which provides an explanation of the POI GUI notification, according to an exemplary embodiment.

FIG. 13 is an email generated by the system of FIG. 2 for a badge trace, according to an exemplary embodiment.

FIG. 14 is an interface for generating a badge trace interface for setting up badge traces that can be managed by the system of FIG. 2, according to an exemplary embodiment.

FIG. 15 is the interface illustrated in FIG. 14 including a user selection element for selecting a user to be traced for the badge trace, according to an exemplary embodiment.

FIG. 16 is the interface illustrated in FIG. 14 including a user selection element for selecting a user to be notified for the badge trace, according to an exemplary embodiment.

FIG. 17 is the interface illustrated in FIG. 14 including information for a generated badge trace, according to an exemplary embodiment.

FIGS. 18-21 are the interface illustrated in FIG. 14 including additional options for generating the badge trace, according to an exemplary embodiment.

FIG. 22 is the interface illustrated in FIG. 14 including an indication that no badge traces are active, according to an exemplary embodiment.

FIGS. 23-25 are the interface illustrated in FIG. 14 including an indication of active badge traces and inactive badge traces, according to an exemplary embodiment.

FIG. 26-28 are the interface illustrated in FIG. 14 illustrating a user scrolling up and down, according to an exemplary embodiment.

FIG. 29 is the interface illustrated in FIG. 14 including an indication of a new badge trace being generated, according to an exemplary embodiment.

FIG. 30 is an interface managed by the system of FIG. 2 including information of a badge trace, according to an exemplary embodiment.

FIG. 31 are interface elements for adjusting a badge to be traced of a badge trace, according to an exemplary embodiment.

FIG. 32 are interface elements for adjusting, a user to notify for the badge trace, a date that the badge trace will expire on, and a building at which to perform the badge trace, according to an exemplary embodiment.

FIG. 33 are interfaces including badge trace information that has been specified by a user and a badge trace where information has not been specified by the user, according to an exemplary embodiment.

FIG. 34 are interfaces illustrating information for a badge trace being edited and saved by a user, according to an exemplary embodiment.

FIG. 35 is an interface illustrating details for a badge trace that can be deleted or edited, according to an exemplary embodiment.

### DETAILED DESCRIPTION

### Overview

Referring generally to the FIGURES, systems and methods for notifying an individual regarding a person of interest alarm (POI) via a graphical user interface (GUI) notification is shown, according to various exemplary embodiments. Security operators using large security monitoring systems handle numerous alarms and alerts on a daily basis. Effectively sorting and responding to alarms and alerts requires human investigation and decision making. Systems that monitor numerous buildings, sites, or locations, either on-location or remotely, present challenges for a security operator. In larger systems, numerous different alarms and security events occur, generating high volumes of data, which are difficult for operators to process effectively. Tools that allow security operators to focus on the most relevant information about alarms allow for a faster response time. The expression ‘person of interest’ (POI) is commonly used to describe an individual whose presence in a monitored area is significant for security reasons. This could be because the person presents a heightened security risk or because the person is a senior or important individual within an organization. An individual can be manually added to a POI list or automatically added to a POI list, for example, based on analysis of anomalous activities. Efficiently identifying the presence of persons of interest will allow security operators to take earlier appropriate actions.

The POI GUI notification can be in the form of an email communication informing one or more notifiable individuals of a POI alarm occurring within the monitored area. The notification provides the notifiable individual with detailed, contextual information about the POI, the activity detected, the threat posed (if any), and other relevant information. Only the most relevant information can be presented to the notifiable person and any empty data fields can be omitted from the interface. This simplifies the way information is presented, making it easier for users to focus on the most important information. The interface may provide a means for the notifiable person to view the person of interest alarm details for further insight or action. The POI GUI notification described herein can be used as part of a security monitoring system, providing detailed and relevant information, together with a direct means of accessing the alarm for further action. The POI GUI notification described herein may improve upon currently available technology by storing POI information, detecting a POI from security data received from security components, generating a POI email including a POI identity, a detected activity associated with the POI, a threat posed, and specific response actions, and notifying a relevant individual with the POI email. The system described herein can store POI descriptive information, vehicle information, contact information, and historical record information in a data structure. Additionally or alternatively, the system described herein may integrate with existing security databases. For example, the system described herein may import an existing POI database, and flag POI's and generate POI notification based on the POI database. Furthermore, the system described herein may format POI notifications to integrate with existing alarm interfaces. For example, the system described herein may surface POI notifications in an existing alarm interface. Detection of a POI may be accomplished by matching security data received from security components to the information stored in the data structure. Response procedures may be tailored to the type of security alarm by storing a number of rules in the system described herein. The rules may specify different POI email recipients and POI email contents based on the location, type of alarm, and POI identity.

Building with Security System

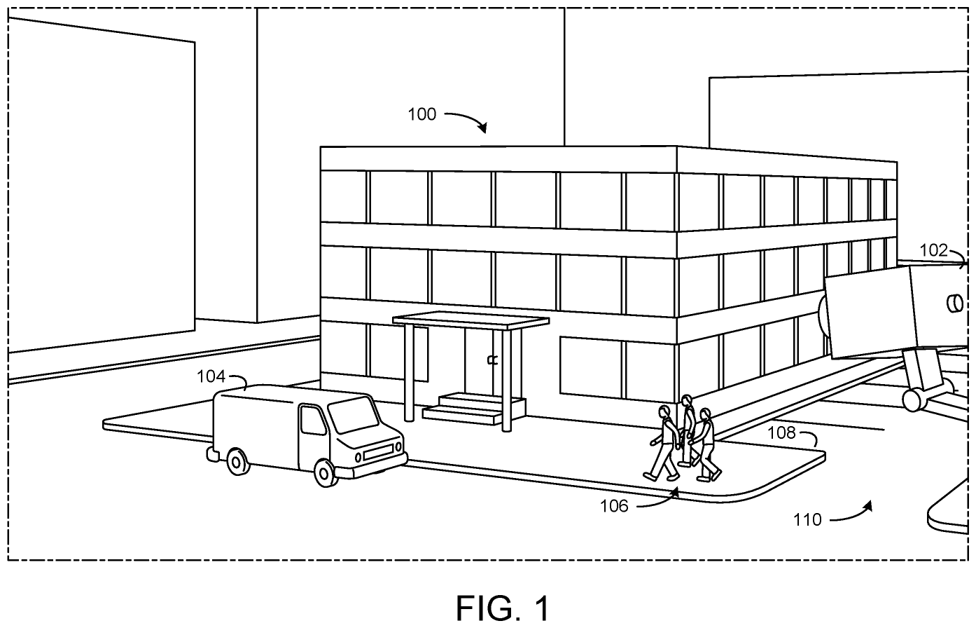

Referring now to FIG. 1, a building 100 with a security camera 102 and a parking lot 110 is shown, according to an exemplary embodiment. The building 100 is a multi-story commercial building surrounded by the parking lot 110 but can be any type of building in some embodiments. The building 100 may be a school, a hospital, a place of business, a residence, an apartment complex, etc. The building 100 may be associated with the parking lot 110.

Both the building 100 and the parking lot 110 are at least partially in the field of view of the security camera 102. In some embodiments, a multiple security camera 102 may be used to capture the entire building 100 and parking lot 110 not in (or in to create multiple angles of overlapping or the same field of view) the field of view of a single security camera 102. The parking lot 110 may be used by one or more vehicles 104 where the vehicles 104 may be either stationary or moving (e.g. delivery vehicles). The building 100 and parking lot 110 may be further used by one or more pedestrians 106 who can traverse the parking lot 110 and/or enter and/or exit the building 100. The building 100 may be further surrounded by a sidewalk 108 to facilitate the foot traffic of one or more pedestrians 106, facilitate deliveries, etc. In some embodiments, the building 100 may be one of many buildings belonging to a single industrial park or commercial park having a common parking lot and security camera 102. In another embodiment, the building 100 may be a residential building or multiple residential buildings that share a common roadway or parking lot.

In some embodiments, the security camera 102 is installed for purposes of monitoring a parking lot 110 and/or sidewalk 108 for accumulated snow. For example, the security camera may be configured to communicate with an image analysis device (e.g., convolutional neural network) to determine if the parking lot 110 or sidewalk 108 are covered with snow and accordingly require snow removal services. In such embodiments, vehicles 104 and/or pedestrians 106 could partially occlude the parking lot 110 or sidewalk 108. When the parking lot 110 and sidewalk 108 are partially occluded, it is possible that an image analysis system could inaccurately classify the parking lot 110 or sidewalk 108 as being covered in snow.

In some embodiments, the security camera 102 is configured to use an image analysis system to observe the parking lot 110 for the purpose of determining how many parking spaces are open and/or occupied. In some embodiments, the security camera 102 could be configured to observe the entrance(s) and/or exit(s) of building 100 for the purposes of counting the number of pedestrians 106 enter or exit the building. In this embodiment, for example, vehicles 104 might partially occlude the entrance(s) and/or exit(s) of the building 100.

### Person of Interest (POI) Building Security System

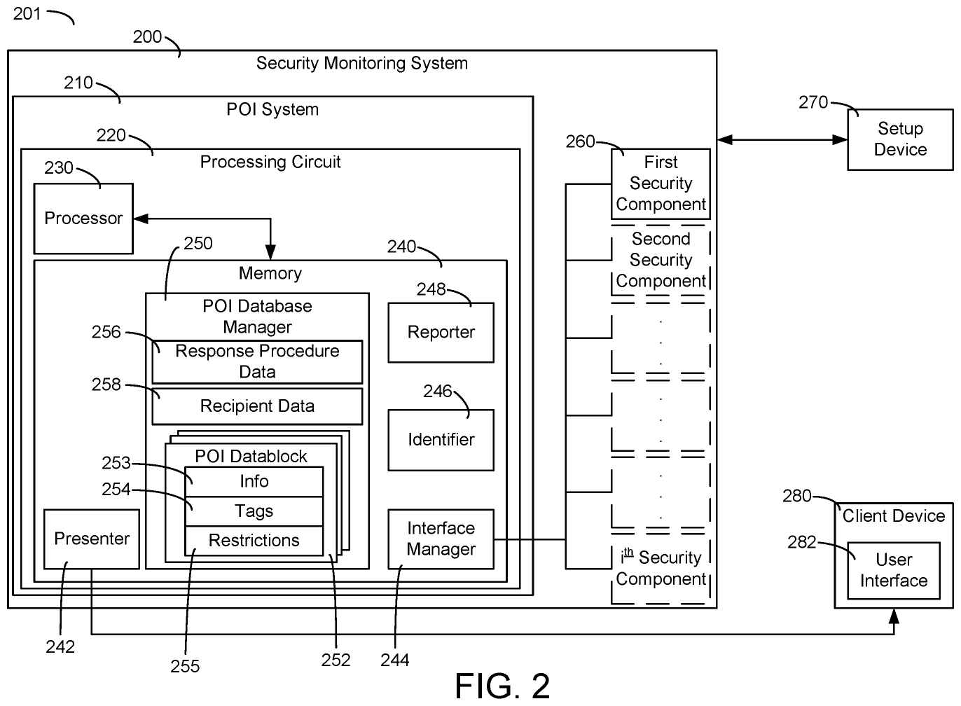

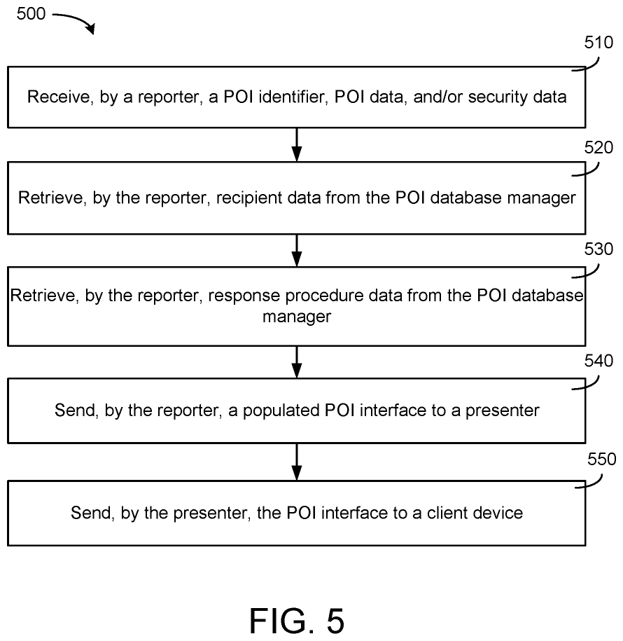

Referring now to FIG. 2, a system 201 is shown, according to an example embodiment. System 201 can be implemented in building 100 as described with reference to FIG. 1 to automatically monitor and control various building functions and systems. In brief overview, the system 201 may monitor security data and generate POI notifications based on the security data. In various embodiments, the system 201 integrates and/or augments an existing security system. For example, a corporate security team may maintain a POI database having POI information associated with a number of POIs. System 201 may integrate with the POI database, and generate POI notifications by analyzing the security data to detect POI's in the POI database. In some embodiments, the POI notifications may be integrated with an alarm interface. System 201 is shown to include security monitoring system 200, setup device 270 and client device 280. The security monitoring system 200 can be configured to generate a GUI notification for notifying a notifiable person of a POI alarm, as described in greater detail with further reference to FIGS. 5-12.

The security monitoring system 200 is shown to include a POI system 210 and a first security component 260. The POI system 210 includes a processing circuit 220. Processing circuit 220 includes processor 230 and memory 240. The processor 230 can be a general purpose processor, an application specific integrated circuit (ASIC), one or more field programmable gate arrays (FPGAs), a group of processing components, or other suitable electronic processing components. Processor 230 can include a memory 240.

The memory 240 can include one or more devices (e.g., memory units, memory devices, storage devices, etc.) for storing data and/or computer code for completing and/or facilitating the various processes described in the present disclosure. The memory 240 can include random access memory (RAM), read-only memory (ROM), hard drive storage, temporary storage, non-volatile memory, flash memory, optical memory, or any other suitable memory for storing software objects and/or computer instructions. The memory 240 can include database components, object code components, script components, or any other type of information structure for supporting the various activities and information structures described in the present disclosure. The memory 240 can be communicably connected to the processor 230 via the processing circuit 220 and can include computer code for executing (e.g., by the processor 230) one or more processes described herein.

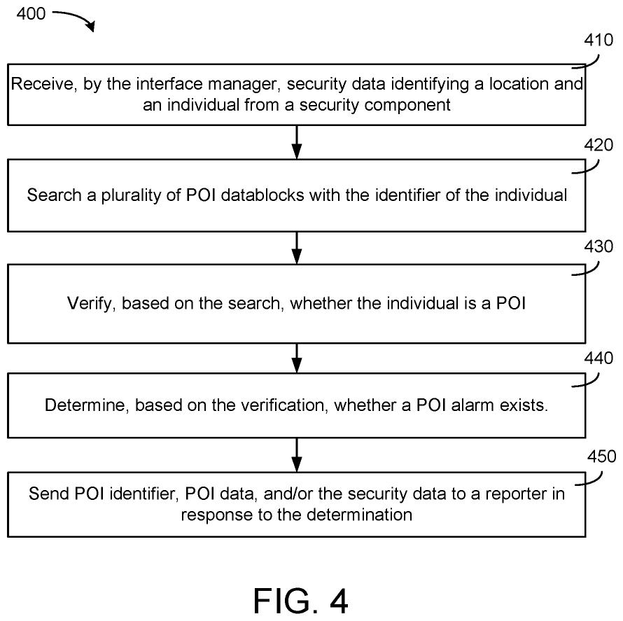

The memory 240 is shown to include an identifier module, shown as identifier 246, and a reporter module, shown as reporter 248. The identifier 246 can be configured to identify a POI alarm given security data from one or more security components 260, as described in greater detail with further reference to FIG. 4. Reporter 248 can be configured to report a POI alarm in response to the determination of a POI alarm by the identifier 246.

The memory 240 is shown to include an interface manager 244. The interface manager 244 can connect the POI system 210 to the plurality of security components 260 and receives security data therefrom. In some embodiments, interface manager 244 is part of other components (e.g., processor 230, POI system 210, etc.), or can be a separate entity entirely. In some embodiments, interface manager 244 can be a hardware component (e.g., router, controller, network switch, gateway, bridge, etc.), while in some embodiments, interface manager 244 can be a software component (e.g., database handler, object code, script, etc.). Interface manager 244 can be communicably connected to the plurality of security components 260 through the POI system 210, according to the exemplary embodiment. In some embodiments, interface manager 244 can be communicably connected to the reporter 248 through the processing circuit 220.

The memory 240 is shown to include a presenter module, shown as presenter 242.

Presenter 242 can send a POI GUI notification from the reporter 248 to the one or more client devices 280. According to the exemplary embodiment, the POI GUI notification can take the form of an email. However, in some embodiments, the POI GUI notification can take other forms (e.g., push notification, SMS text message, pager alert, instant message, phone call, etc.). In some embodiments, the POI GUI notification may take the form of an alarm in an alarm interface. For example, the POI GUI notification may be an alarm added to the alarm queue of a security system or BMS. Presenter 242 can be connected to client device 280 and processor 230, according to the exemplary embodiment. In some embodiments, presenter 242 can be part of other components (e.g., processor 230, POI system 210, etc.), or can be a separate entity entirely.

The memory 240 is shown to include a POI database module, shown as POI database manager 250. POI database manager 250 can maintain data relevant to operation of the POI system 210. POI database manager 250 can include one or more POI datablock(s) 252, response procedure data 256, and recipient data 258. In some embodiments, POI database manager 250 can be a hardware component (e.g., server, load balancing system, etc.), while in some embodiments, POI database manager 250 can be a software component (e.g., database management system, application programming interface, content management system, etc.). POI database manager 250 can be communicably connected to processor 230, according to the exemplary embodiment. However, in some embodiments, POI database manger 250 can be part of other components (e.g., processor 230, POI system 210, etc.), or can be a separate entity entirely.

In some embodiments, the one or more POI datablock(s) 252 can be identified through a unique POI identifier. Each of the one or more POI datablock(s) 252 can correspond to an individual POI. POI datablock(s) 252 may contain information relevant to an individual POI (e.g., name, alias, profile picture, badge number, category of threat, contact information, position, employee type, assignment, sex, race, age, height, weight, eye color, hair color, facial features, traits, tattoos, vehicle information, restriction information, etc.). The one or more POI datablock(s) 252 are shown to include POI info, shown as info 253, POI tags, shown as tags 254, and/or POI restrictions, shown as restrictions 255, according to the exemplary embodiment. Info 253 can include POI specific information as described above for POI datablock 252. Tags 254 can include brief descriptive categories of individual POI threats (e.g., threat of violence, etc.). Restrictions 255 can include POI specific rules used to determine the presence of a POI alarm given the POI (e.g., presence within a restricted area, violation of restraining order, presence of terminated employee, etc.).

The response procedure data 256 may contain information relating to the required response protocol for a POI alarm (e.g., receptionist required actions, security personnel required actions, outside security calls to police, fire, ambulance, etc.) to be included in the POI GUI notification. The response procedure data 256 may contain steps, actions, or instructions individualized to the specific POI alarm. In some embodiments, the response procedure data 256 may contain embedded scripts to trigger further action. According to the exemplary embodiment, response procedure data 256 can be individualized and/or associable with specific security monitored locations (e.g., buildings, parking lots, campuses, cities, rooms, etc.), individual POI's (e.g., terminated employee, high-profile individual, violent individual, etc.), POI tags (e.g., threat of violence, etc.), and/or POI alarms (e.g., presence within a restricted area, violation of restraining order, presence of terminated employee, etc.). By way of example, a first POI alarm for the presence of a terminated employee may be associated with a first response procedure (e.g., monitor individual, etc.), while a second POI alarm for a terminated employee with an associated tag ‘threat of violence’ may be associated with a second response (e.g., alert the police, etc.).

The recipient data 258 may contain information relating to the one or more recipient(s) of the POI GUI notification. Recipient data 258 can include email addresses, phone numbers, messenger contacts, pager numbers, IP addresses, and/or other contact information not listed herein. Recipient data 258 can include information relating to the recipient (e.g., name of recipient, position, alternate contacts, etc.). In some embodiments, recipient data 258 may be individualized and/or associable with specific security monitored locations (e.g., buildings, parking lots, campuses, cities, rooms, etc.), individual POI'S (e.g., terminated employee, high-profile individual, violent individual, etc.), POI tags (e.g., threat of violence, etc.), and/or POI alarms (e.g., presence within a restricted area, violation of restraining order, presence of terminated employee, etc.). By way of example, a first POI alarm for the presence of a terminated employee may be associated with a first recipient (e.g., a human resources manager, etc.), while a second POI alarm for a terminated employee with an associated tag ‘threat of violence’ may be associated with a second recipient (e.g., a security officer, etc.).

The one or more security component 260 can be configured to provide security data to the POI system 210. The one or more security component 260 can be a physical hardware element (e.g., ingress card reader, security camera, access controller, retina scanner, fingerprint reader, etc.) and/or a non-physical element (e.g., biometric analysis, social media analysis, facial-recognition, license plate analyzer, etc.). According to the exemplary embodiment, the one or more security component 260 can be communicably coupled to the POI system 210 through the interface manager 244.

The setup device 270 can be configured to send one or more POI datablock(s) 252 and/or POI data (e.g., info 253, tags 254, restrictions 255, etc.) to the security monitoring system 200 in order to set up the POI GUI notifications. In some embodiments, setup device 270 may be a computer. However, in some embodiments, setup device 270 can take other forms (e.g., a tablet, phone, controller, script, program, etc.). Additionally, in some embodiments, setup device 270 can be part of security monitoring system 200. According to the exemplary embodiment, setup device 270 can be connected to security monitoring system 200.

The client device 280 may receive POI GUI notifications from the POI system 210. According to the exemplary embodiment, client device 280 may take the form of an email client. However, in some embodiments, client device 280 can take other forms (e.g., pager, cell phone, controller, switchboard, building management system, script, program, computer, server, etc.). According to the exemplary embodiment, client device 280 may contain user interface 282. The user interface 282 can be a touchscreen or other type of electronic display configured to present information to a user in a visual format (e.g., as text, graphics, etc.) and receive input from a user (e.g., via a touch-sensitive panel). For example, the user interface 282 may include a touch-sensitive panel layered on top of an electronic visual display. A user can provide inputs through simple or multi-touch gestures by touching the user interface 282 with one or more fingers and/or with a stylus or pen. The user interface 282 can use any of a variety of touch-sensing technologies to receive user inputs, such as capacitive sensing (e.g., surface capacitance, projected capacitance, mutual capacitance, self-capacitance, etc.), resistive sensing, surface acoustic wave, infrared grid, infrared acrylic projection, optical imaging, dispersive signal technology, acoustic pulse recognition, or other touch-sensitive technologies known in the art. Many of these technologies allow for multi-touch responsiveness of user interface 282 allowing registration of touch in two or even more locations at once. The display may use any of a variety of display technologies such as light emitting diode (LED), organic light-emitting diode (OLED), liquid-crystal display (LCD), organic light-emitting transistor (OLET), surface-conduction electron-emitter display (SED), field emission display (FED), digital light processing (DLP), liquid crystal on silicon (LCoC), or any other display technologies known in the art. In some embodiments, the user interface 282 is configured to present visual media (e.g., text, graphics, etc.) without requiring a backlight. In some embodiments, client device 280 may not contain user interface 282.

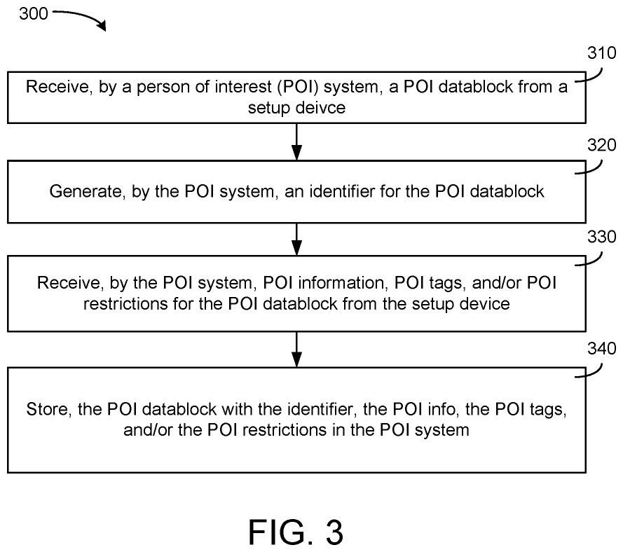

Referring now to FIG. 3, a flow diagram of a process 300 that can be performed by the POI system 210 is shown, according to an exemplary embodiment. The process 300 can include generating and storing the one or more POI datablock(s) 252 used by the POI system 210 to generate and send the POI GUI notifications.

In step 310, the POI system 210 can receive from the setup device 270 a new POI datablock. The setup device 270 can take the form of a computer. In some embodiments, the POI system may present an input text form to the setup device 270 that can be filled out by a user using the setup device 270. Each new POI datablock can correspond to an individual POI. The new POI datablock can include POI data (e.g., info 253, tags 254, restrictions 255, etc.). POI data (e.g., info 253, tags 254, restrictions 255, etc.) may contain information relevant to an individual POI (e.g., name, alias, profile picture, badge number, category of threat, contact information, position, employee type, assignment, sex, race, age, height, weight, eye color, hair color, facial features, traits, tattoos, vehicle information, restriction information, etc.). POI data (e.g., info 253, tags 254, restrictions 255, etc.) can include info 253, tags 254, and/or restrictions 255. Info 253 can include POI specific information as described above for POI data (e.g., info 253, tags 254, restrictions 255, etc.). Tags 254 can include brief descriptive categories of individual POI threats (e.g., threat of violence, etc.). Restrictions 255 can include POI specific rules used to determine the presence of a POI alarm given the POI (e.g., presence within a restricted area, violation of restraining order, presence of terminated employee, etc.). In some embodiments, the completed input text form is submitted by the user using setup device 270, and parsed by the POI system 210 to produce a new POI datablock. In some embodiments, the setup device 270 can send a POI datablock data structure. By way of example, the setup device 270 could parse an input text form and produce a POI datablock data structure to send to the POI system 210. Communication between the setup device 270 and POI system 210 can be through a network, a communications connection (either hardwired, wireless, or a combination of hardwired or wireless), or another technology known in the art.

In step 320, the POI system 210 can generate an identifier for the new POI datablock. The identifier can uniquely identify an individual POI datablock. The POI system 210 can generate a unique individualized identifier by maintaining a list of assigned identifiers and incrementally assigning a new POI datablock with an identifier value sequentially greater than that contained in the list of assigned identifiers. By way of example, the first POI datablock may be stored with identifier value “10000” and the second POI datablock may be stored with identifier value “10001.” In some embodiments, the POI system 210 can generate an identifier for the new POI datablock by other means not here mentioned.

In step 330, the POI system 210 can receive from the setup device 270 POI data (e.g., info 253, tags 254, restrictions 255, etc.). The setup device 270 can take the form of a computer. In some embodiments, the POI system may present an input text form to the setup device 270 that can be filled out by a user using the setup device 270. The input text form may contain fields for info 253, tags 254, and/or restrictions 255. The user may enter the info 253, tags 254 and/or restrictions 255 using the setup device 270. In some embodiments, the completed input text form is submitted by the user using setup device 270 and parsed by the POI system 210 to produce info 253, tags 254, and/or restrictions 255. In some embodiments, the setup device 270 can parse and send info 253, tags 254, and/or restrictions 255 itself. By way of example, the setup device 270 could parse an input text form and produce info 253, tags 254, and restrictions 255 to send to the POI system 210. Communication between the setup device 270 and POI system 210 can be through a network, a communications connection (either hardwired, wireless, or a combination of hardwired or wireless), or another technology known in the art.

In step 340, the new POI datablock containing POI data (e.g., info 253, tags 254, restrictions 255, etc.) can be stored with the identifier in the POI system 210. The new POI datablock can be stored as a data structure. The new POI datablock can stored such that it can be uniquely identified using the associated identifier. The new POI datablock may be stored by POI Database Manager 250 in a memory. The memory can include random access memory (RAM), read-only memory (ROM), hard drive storage, temporary storage, non-volatile memory, flash memory, optical memory, or any other suitable memory for storing software objects and/or computer instructions.

Referring now to FIG. 4, a flow diagram of an identification process 400 for the POI system 210 is shown, according to an exemplary embodiment. In some embodiments, the identifier 246 can be configured to perform the identification process 400. However, in some embodiments, other components can be configured to perform the identification process 400. The POI system 210 can be configured to perform the identification process 400. Furthermore, any computing device as described herein can be configured to perform the process 400. In brief overview, identifier 246 is configured to analyze security data to detect POI's. Detecting POI's may include badge detection, facial recognition, license plate recognition, pattern recognition, and any other form of analysis.

In step 410, the interface manager 244 can receive from one or more security components 260 security data identifying a location and an individual. In some embodiments, the identification may take the form of a general identifier. Security data may include a badge number, access controller identifier, finger print data, retina scan data, biometric data, facial recognition indication, event time, component location, and/or other information not here included. A general identifier may be a high-level descriptor of the POI and may include height, age, weight, name, nickname, alias, race, biometric data, voice data, license plate, and/or other information not here listed. By way of example, a security component 260 could report badge number 142094 scanned in at location 12 at 12:09 A.M.

In step 420, the identifier 246 can search a plurality of POI datablocks 252 with the general identifier of the individual received in step 410. The identifier 246 can search the plurality of datablocks 252 by matching the general identifier of the individual to information contained in the plurality of datablocks 252. By way of example, the identifier 246 could match the received badge number “142094” to stored badge number “142094” contained in info 253. The search may be a binary search, a ranked search, or another search method not here listed.

In step 430, the identifier 246 may verify, based on the search, whether the individual is a POI. According to the exemplary embodiment, the identifier 246 may verify the individual as a POI if the identifier of the general identifier matches a POI identifier associated with a POI datablock 252 stored in memory 240. Any individual with an associated POI datablock 252 can be a POI. By way of example, the identifier 246 could verify the individual with badge number 142094 as a POI based on a matching badge number of 142094 contained in info 253 associated with a POI datablock 252.

In step 440, the identifier 246 can determine, given the POI identifier, whether a POI alarm exists. According to the exemplary embodiment, the identifier 246 can determine the existence of a POI alarm by comparing the security data to the restrictions 255 associated with the POI datablock 252 identified in step 430. Restrictions 255 can include POI specific rules used to determine the presence of a POI alarm given the POI (e.g., presence within a restricted area, violation of restraining order, presence of terminated employee, etc.). By way of example, if security data indicates that a POI is in an area listed as restricted in the restrictions 255 of the POI datablock 252 associated with the POI, then a POI alarm can be determined to exist.

In step 450, in response to determining the presence of a POI alarm, the identifier 246 may send to the reporter 248 the POI identifier, security data, and/or POI data (e.g., info 253, tags 254, restrictions 255, etc.) associated with the POI alarm. The identifier 246 can send information to the reporter 248 to build a POI GUI notification which includes information associated with the POI. The identifier 246 can send the POI identifier, security data, info 253, tags 254, and/or restrictions 255 as a data structure. By way of example, the identifier 246 can send info 253, tags 254, and/or restrictions 255 as a POI datablock data structure.

Referring now to FIG. 5, a flow diagram of a reporting process 500 for the POI system 210 is shown, according to an exemplary embodiment. According to the exemplary embodiment, the reporting process 500 can be carried out by the reporter 248. However, in some embodiments, other components (e.g., processor 230, POI system 210, etc.) can be configured to perform the reporting process 500. The reporting process 500 can arrange information associated with a POI alarm to be easily understood by a user.

At step 510, the reporter 248 can receive from the identifier 246, the POI identifier, security data, and/or POI data (e.g., info 253, tags 254, restrictions 255, etc.) associated with the POI alarm. The POI identifier, security data, and/or POI data (e.g., info 253, tags 254, restrictions 255, etc.) may be received from the identifier 246 as a data structure or as unstructured data. In some embodiments, the reporter 248 can parse or otherwise structure the data received from the identifier 246.

At step 520, the reporter 248 can retrieve from the POI database manager 250 recipient data 258 associated with the POI alarm. The recipient data 258 may contain information relating to the one or more recipient(s) of the POI GUI notification. Recipient data 258 can include email addresses, phone numbers, messenger contacts, pager numbers, IP addresses, and/or other contact information not listed herein. Recipient data 258 can include information relating to the recipient (e.g., name of recipient, position, alternate contacts, etc.). Recipient data 258 may be individualized and/or associable with specific security monitored locations (e.g., buildings, parking lots, campuses, cities, rooms, etc.), individual POI'S (e.g., terminated employee, high-profile individual, violent individual, etc.), POI tags (e.g., threat of violence, etc.), and/or POI alarms (e.g., presence within a restricted area, violation of restraining order, presence of terminated employee, etc.). The reporter 248 can retrieve recipient data 258 through a defined rules process. In some embodiments, a user may define a set of rules which determine the appropriate recipients for a given alarm. By way of example, the set of rules could be:
if: <alarm occurs in building 3> & <tag: ‘threat of physical violence’ is present>|<restriction: ‘banned from building 3’ is present> then: building 3 security are recipients

In some embodiments, the POI system 210 may contain default rules that can be selectively overwritten by the user. In some embodiments, the reporter 248 may not use a defined rules process and may retrieve recipient data 258 through other means not here mentioned.

At step 530, the reporter 248 can retrieve from the POI database manager 250 response procedure data 256. The response procedure data 256 may contain information relating to the required response protocol for a POI alarm (e.g., receptionist required actions, security required actions, etc.) to be included in the POI GUI notification. The response procedure data 256 may contain steps, actions, or instructions individualized to the specific POI alarm. In some embodiments, the response procedure data 256 may contain embedded scripts to trigger further action. Response procedure data 256 can be individualized and/or associable with specific security monitored locations (e.g., buildings, parking lots, campuses, cities, rooms, etc.), individual POI'S (e.g., terminated employee, high-profile individual, violent individual, etc.), POI tags (e.g., threat of violence, etc.), and/or POI alarms (e.g., presence within a restricted area, violation of restraining order, presence of terminated employee, etc.). The reporter 248 can retrieve response procedure data 256 through a defined rules process. In some embodiments, a user may define a set of rules which determine the appropriate response procedures for a given alarm. By way of example, the set of rules could be:
if: <alarm occurs in building 3> & <tag: ‘medical emergency’ is present> then: response procedure is: ‘call 911’

In some embodiments, the POI system 210 may contain default rules and response procedures that can be selectively overwritten by the user. In some embodiments, the reporter 248 may not use a defined rules process, may use a precomposed emergency response document, or may retrieve response procedure data 256 through other means not here mentioned.

At step 540, the reporter 248 can send to the presenter 242 a populated POI GUI interface. According to the exemplary embodiment, the populated POI GUI interface may contain the POI data (e.g., info 253, tags 254, restrictions 255, etc.), security data, and/or response procedure data 256 associated with the POI alarm. The reporter 248 may create the populated POI GUI interface by populating fields in a blank POI GUI interface template. In some embodiments, the user may select from multiple existing POI GUI interface templates and/or can edit existing POI GUI interface templates. The POI GUI interface templates may vary depending on the type of POI GUI notification. By way of example, a phone push notification could be shorter and link to a longer report than an email notification.

At step 550, the presenter 242 can send to the client device 280 the populated POI GUI interface. In some embodiments, other components (e.g., processor 230, POI system 210, etc.) can be configured to send the populated POI GUI interface. In some embodiments, client device 280 can take the form of a computer or other forms (e.g., pager, cell phone, controller, switchboard, building management system, script, program, computer, server, etc.). In some embodiments, the POI GUI notification can take the form of an email or other forms (e.g., push notification, SMS text message, pager alert, etc.). The form of the POI GUI notification can be determined by the user. The POI GUI notification may take multiple forms and/or may vary depending on the type of POI alarm.

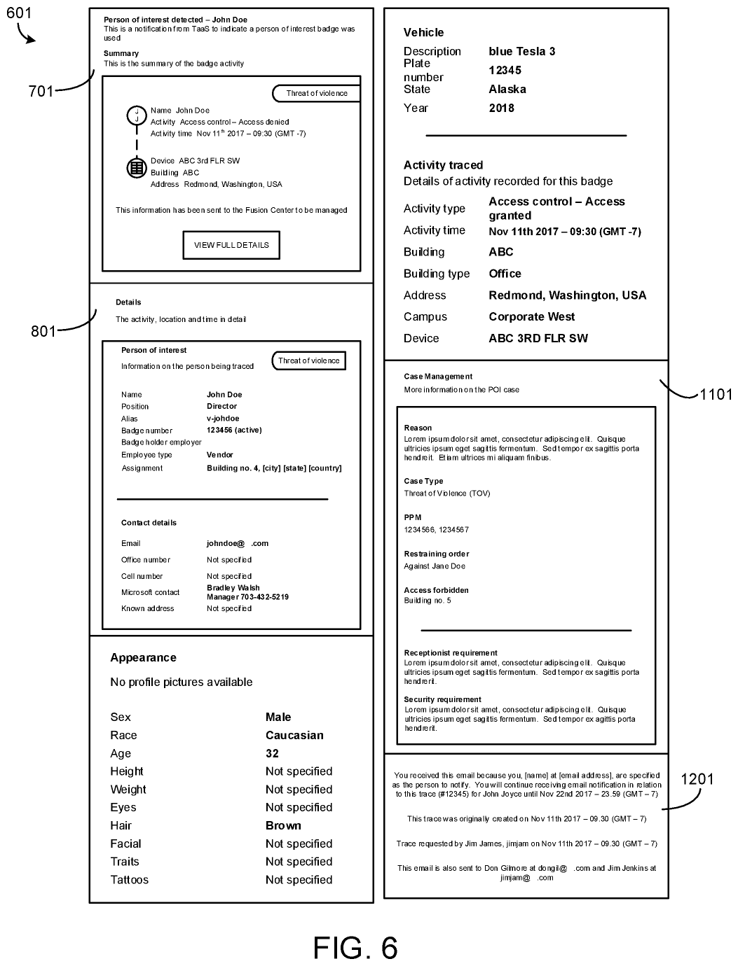

Referring now to FIG. 6, an overview of a POI GUI notification is shown, according to an exemplary embodiment. According to the exemplary embodiment, the POI GUI notification may take the form of an email message, shown as email 601. Email 601 can be organized into sections presented as cards within the notification interface. According to the exemplary embodiment, email 601 may contain summary card 701, details card 801, case management card 1101, and notification text 1201. However, in some embodiments email 601 may contain a different number and/or type of cards not here listed.

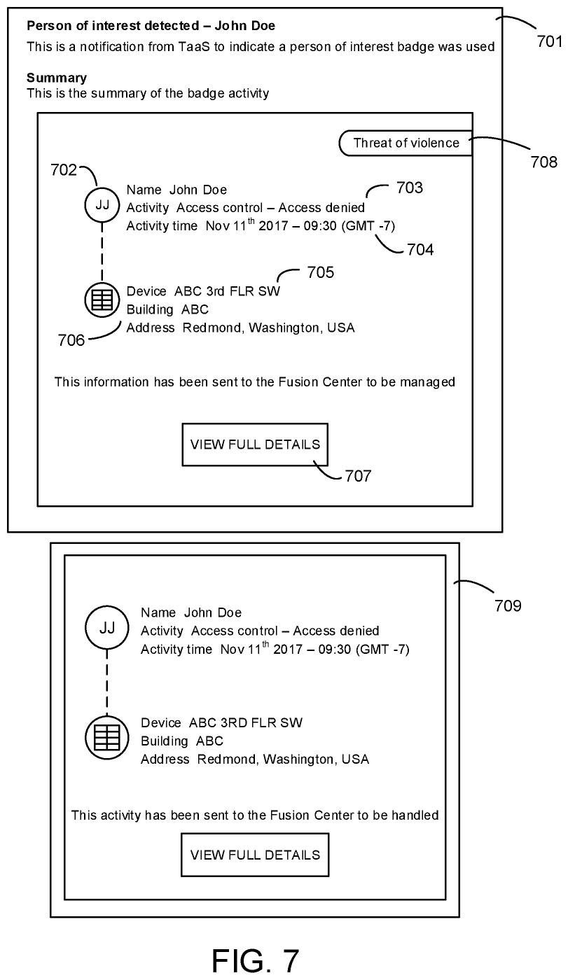

Referring now to FIG. 7, summary card 701 is shown, according to an exemplary embodiment. Summary card 701 may contain threat information 709. In some embodiments, threat information 709 is omitted and/or other information not here listed is included. In some embodiments, threat information 709 may contain a badge number 702, POI alarm type 703, POI alarm time 704, security device 705, building 706, interactive element, shown as view in full details option 707, and tag, shown as threat of violence 708. In some embodiments, threat information 709 may display the name, alias, profile picture, badge number, activity type, time, device name, building name and address, tags and/or other elements not here listed associated with the POI alarm. Summary card 701 can be configured to have a large text size, and contrasting colors to be easily readable by a user. Show in full details option 707 may link to details card 801 or another different card not here included. Summary card 701 can be configured to contain macro or script elements to automate further action. By way of example, summary card 701 may contain a link within the building information 706 to display a map of the associated building. In some embodiments, summary card 701 contains key tips configured to provide additional information to the user when the user interacts with an element of the card. By way of example, upon hovering a mouse over threat of violence 708, the summary card 701 could provide the definition of threat of violence.

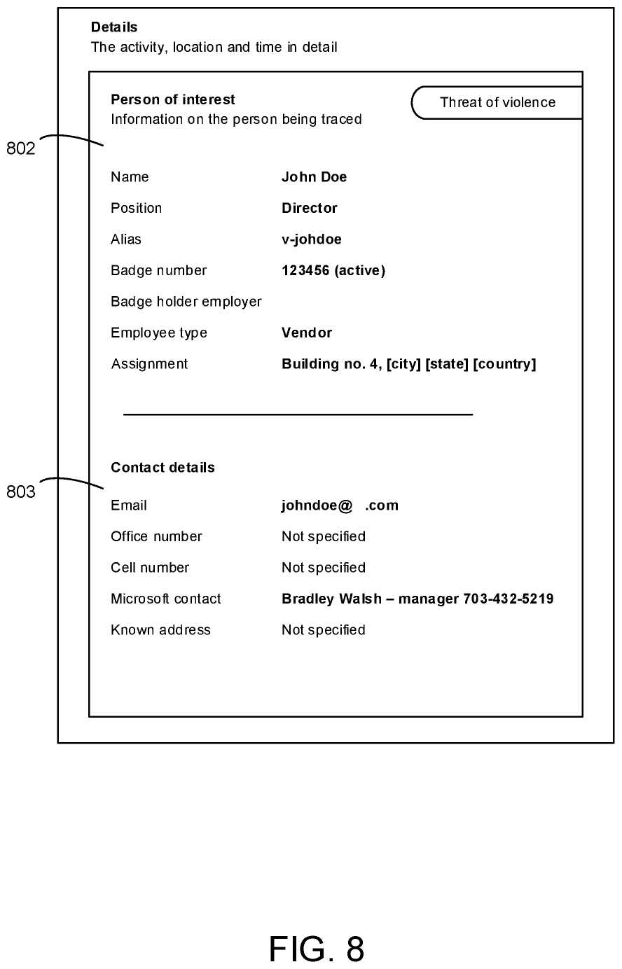

Referring now to FIGS. 8-10, details card 801 is shown, according to an exemplary embodiment. According to the exemplary embodiment, details card 801 may contain subsections person of interest 802, contact details 803, appearance 901, vehicle 1001, and activity traced 1003. However, in some embodiments, details card 801 may contain a different number and/or type of subsections and can vary depending on the parameters discussed above in reference to FIG. 5. Details card 801 can be configured to provide specific details relating to the POI, POI alarm, security data, and/or response procedure associated with the POI alarm.

Referring now specifically to FIG. 8, subsections of details card 801 person of interest 802 and contact details 803 are shown, according to an exemplary embodiment. Person of interest subsection 802 can display information about the person associated with the POI identification associated with the POI alarm. Details card 801 can be configured to contain macro or script elements to automate further action. By way of example, details card 801 may contain a link within the email field of contact details 803 to automatically draft an email to the email address listed. In some embodiments, details card 801 contains key tips configured to provide additional information to the user when the user interacts with an element of the card. By way of example, upon hovering a mouse over threat of violence, the details card 801 could provide the definition of threat of violence. Contact details subsection 803 can display the contact information of the person associated with the POI identification associated with the POI alarm.

Person of interest subsection 802 may include the name, position, alias, badge number, badge holder employer, employee type, assignment, and/or other information not here listed. In some embodiments, person of interest subsection 802 may include a picture of the POI. Person of interest subsection 802 can include tags 254 associated with the POI. Person on interest subsection 802 can include a brief descriptive header of the subsection to orient users to the information contained within the subsection.

Contact details subsection 803 can display the contact information associated with the POI, managers, security personnel, police, and/or other individuals not here listed. Contact details subsection 803 can include an email of the POI, an office number of the POI, a cell number of the POI, an organizational contact of the POI, and/or a known address of the POI. Contact details subsection 803 can include a brief descriptive header of the subsection to orient users to the information contained within the subsection. In some embodiments, contact details subsection 803 includes pronouncers associated with contacts included in the contact details subsection 803.

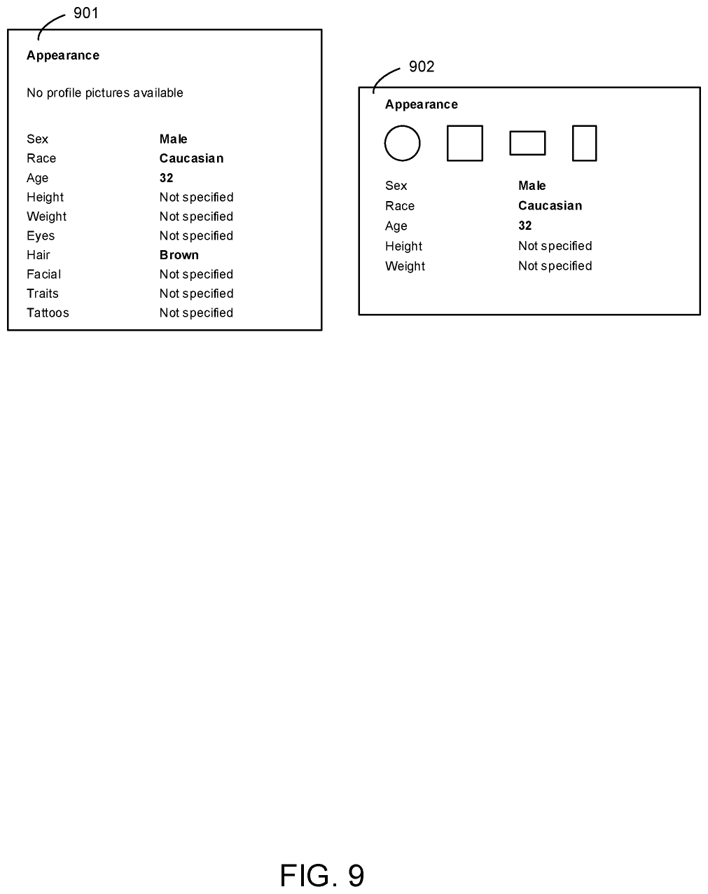

Referring now specifically to FIG. 9, the appearance subsection 901 of the details card 801 is shown, according to an exemplary embodiment. According to the exemplary embodiment, profile pictures 902 can be included in the appearance subsection 901. However, in some embodiments, appearance subsection 901 may contain no profile pictures 902. Appearance subsection 901 can include sex, race, age, height, weight, eye color, hair color, facial features, facial hair features, traits, tattoos, and/or other information not here listed associated with the appearance of the POI. In some embodiments, appearance fields that contain no information can be labeled as ‘Not specified.’ In some embodiments, appearance fields that contain no information can be labeled in a different manner or can be omitted from appearance subsection 901 entirely. Appearance subsection 901 can include a brief descriptive header of the subsection to orient users to the information contained within the subsection.

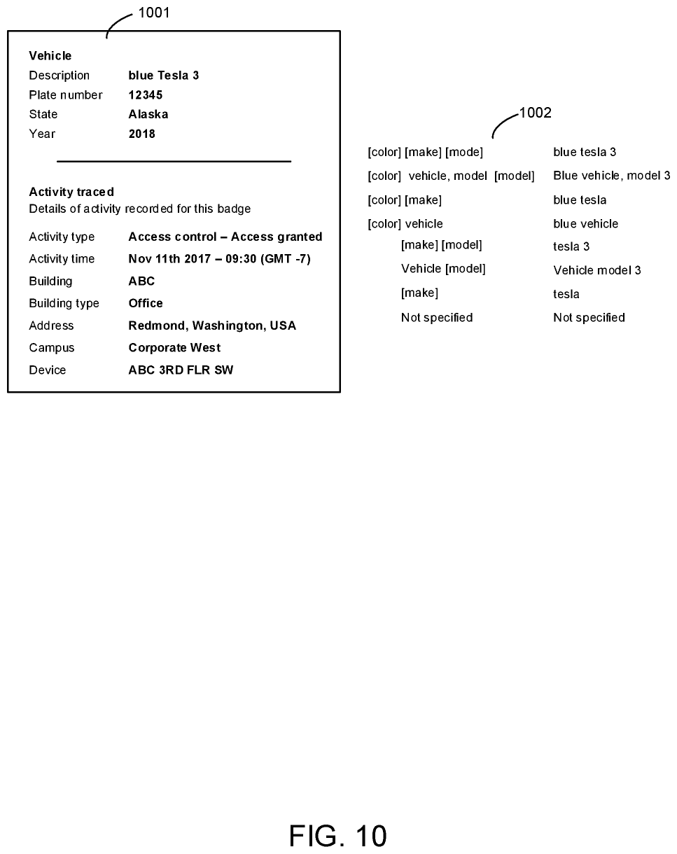

Referring now specifically to FIG. 10, the vehicle 1001 subsection of details card 801 is shown, according to an exemplary embodiment. The vehicle subsection 1001 may display vehicle information 1002. Vehicle subsection 1001 may contain photographs, descriptions, bumper stickers, make/model, and/or other information not contained herein.

Vehicle subsection 1001 may contain a description, plate number, state, year, make/model, color, decals, and/or other information associated with the vehicle of the POI not contained herein. In some embodiments, vehicle subsection 1001 may contain activity traced associated with the POI vehicle including activity type, activity time, building, building type, address, campus, device, and/or other information not contained herein. In some embodiments, vehicle subsection 1001 does not include activity traced associated with the POI vehicle, or contains other information or subsections not here listed. Vehicle subsection 1001 can include a brief descriptive header of the subsection to orient users to the information contained within the subsection.

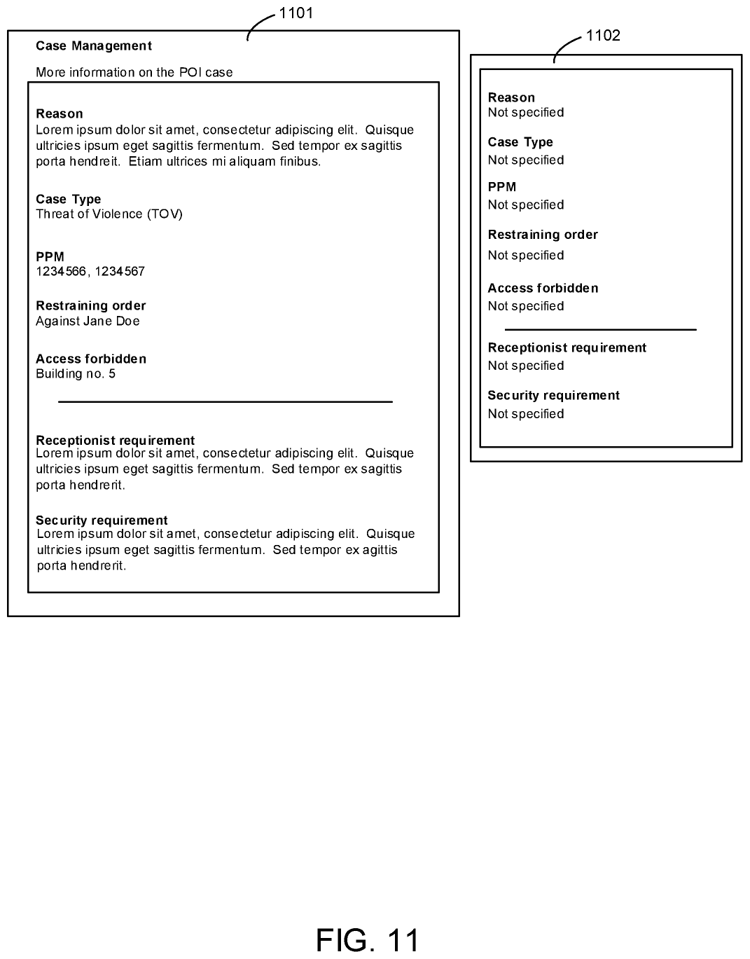

Referring now to FIG. 11, the case management card 1101 is shown, according to an exemplary embodiment. Case management card 1101 can display information on the POI associated with the POI alarm. Information on the POI associated with the POI alarm may include reason, case type (e.g., threat of violence, etc.), reference numbers from external data sources, restraining order information, locations within the monitored area for which access if forbidden, receptionist action requirements, security action requirements, and/or other information not listed herein. In some embodiments, receptionist action requirements and/or security action requirements can include contact information and/or macros or scripts to automate associated required actions. An empty case management card 1102 is shown, according to an exemplary embodiment. In some embodiments, case management fields that contain no information can be labeled as ‘Not specified.’ In some embodiments, case management fields that contain no information can be labeled in a different manner or can be omitted from case management subsection 1101 entirely. Case management card 1101 can include a brief descriptive header of the card to orient users to the information contained within the card. In some embodiments, case management card 1101 may contain a different number and/or type of subsections and can vary depending on the parameters discussed above in reference to FIG. 5.

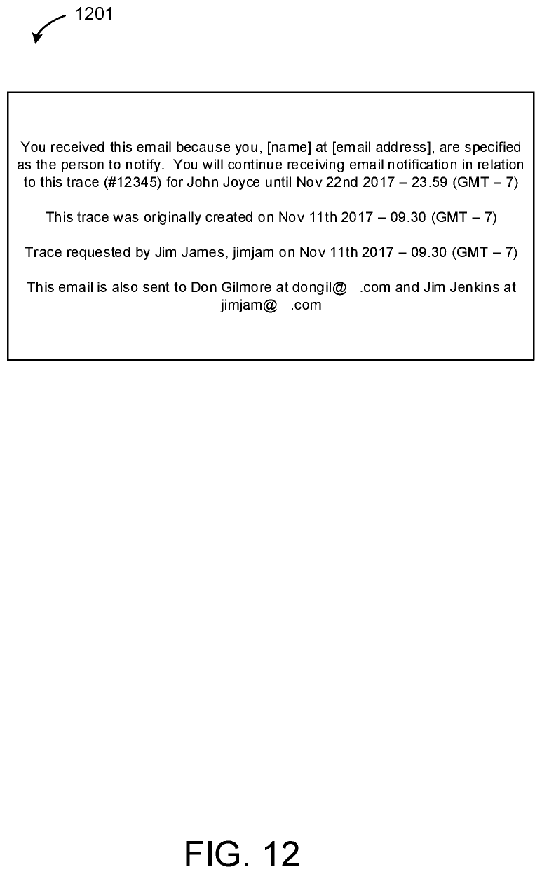

Referring now to FIG. 12, the notification text 1201 accompanying the email 601 is shown, according to an exemplary embodiment. The notification text 1201 may appear at the end of the email 601. The notification text 1201 can be configured to provide contextual information to the user receiving the POI GUI notification including a reason for receiving the email, sender, and other individuals receiving the notification. In some embodiments, the notification text 1201 may include the name and email of the notifiable person, the POI identifier, the name of the POI, expiry date of POI badge, time of the POI alarm, alias of the person who created the POI alarm, expiry date of the POI alarm, name and email of other notifiable person(s) and/or other information not here listed.

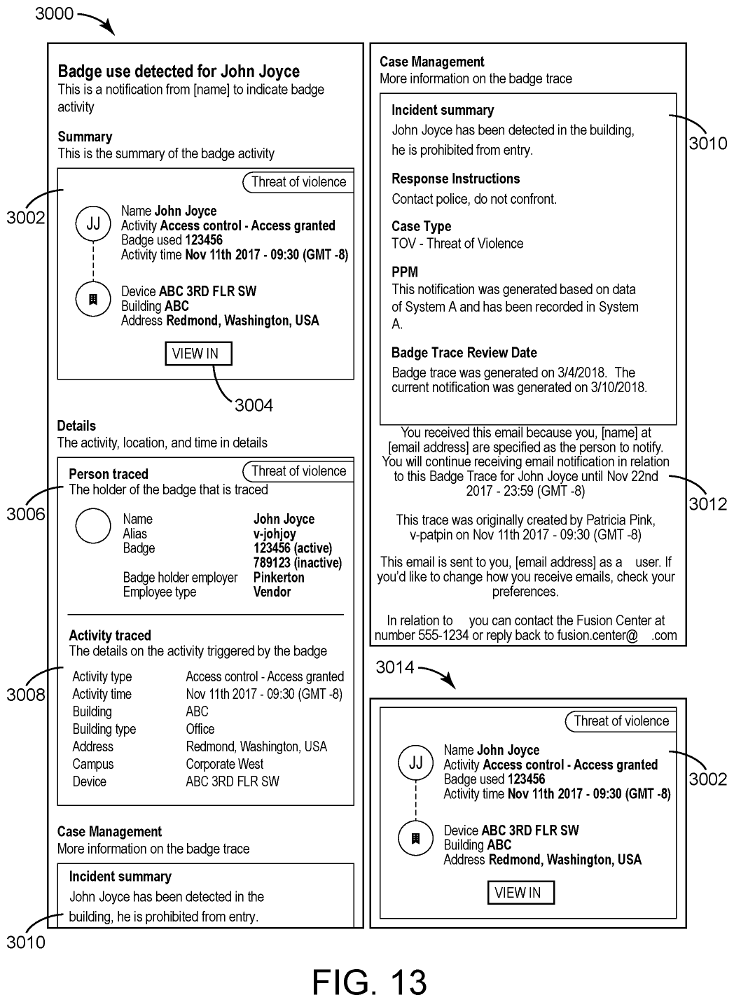

Referring now to FIG. 13, an email interface 3000 is shown that the POI system 210 is configured to generate and send to a user, according to an exemplary embodiment. The interface 3000 informs one or more notifiable people of activities occurring within the monitored area that are associated with a badge trace or other identity trace. The interface 3000 provides the notifiable person with detailed, contextual information about the badge or identity trace, the activity detected, the threat (if any), and other relevant information. Only the most relevant information is presented to the notifiable person and any empty data fields are omitted from the interface. This simplifies the way information is presented, making it easier for users to focus on the most important information. The interface 3000 provides a means for the notifiable person to view the trace details for further insight or action.

The interface 3000 is shown to include a summary card 3002 including identification details of the person and badge being traced, the type of activity (in this example, an access granted event), the date and time of the activity, the device detecting the badge use and its location, and the case type (in this example, threat of violence). The summary card 3002 includes a “View in” option 3004, allowing the user to open a badge trace details page. Where no case type is assigned, the summary card 3002 is displayed without this information, as the view 3014 of the summary card 3002.

The interface 3000 is shown to include a details card 3006. In the details card 3006, the details of the person traced are displayed, including all badge numbers associated with that person. The details card 3006 also includes the details of the activity, such as the type of activity, local time of the activity, building and building type, address, campus, and the device detecting the badge activity 3008. The interface 3000 further includes a case management card 3010. The case management card 3010 provides more information which can be user specified for a particular badge trace.

The interface 3000 includes email footer text 3012 confirming to the recipient that they are the person to be notified in relation to a badge trace and including the expiry date of the badge trace and the identity of the person who created the trace and when the trace was created. The email footer allows the recipient to change their preferences and provides a contact email.

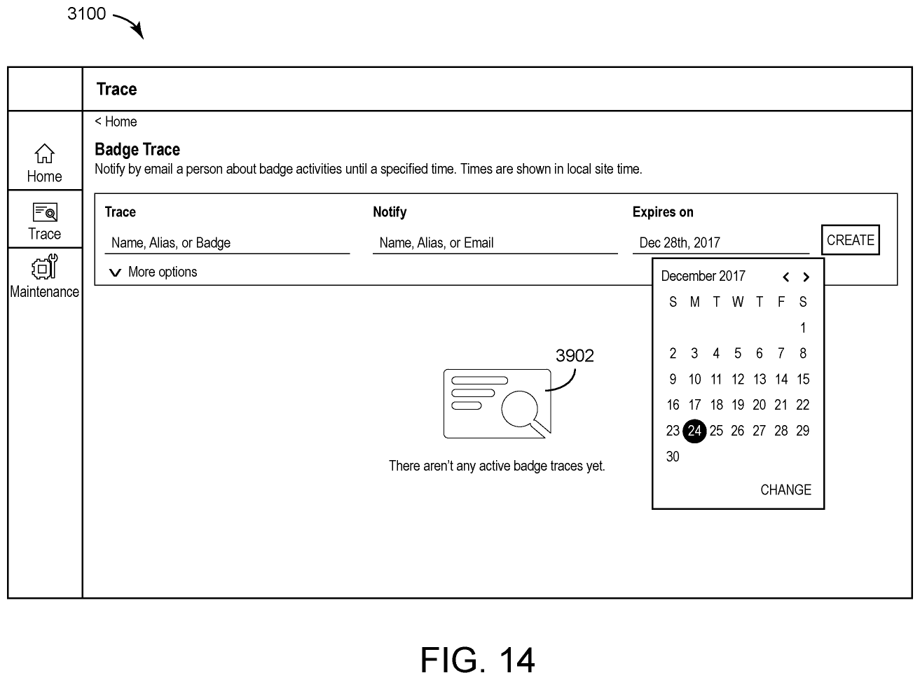

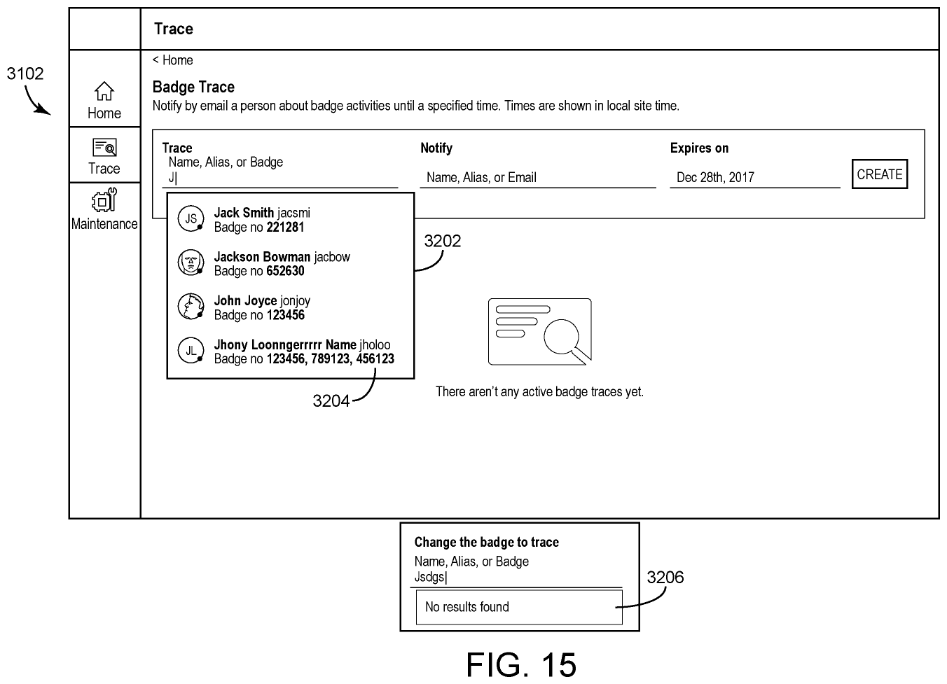

Referring now to FIGS. 14-15, an interface 3100 for generating a new badge trace is shown, according to various exemplary embodiments. The POI system 210 is configured to generate and/or manage the interface 3100, in some embodiments. The interface 3100 is a badge trace home interface which displays when the user selects the “Trace” icon from the menu bar located on the left-hand side of the screen. The badge trace widget 3102 is presented in an unexpanded form and provides input fields to create a new badge trace, in some embodiments. The unexpanded badge trace widget 3102 contains input fields for a particular name, alias, or badge identifier, to locate a person to be notified. The widget 3102 can facilitate searching for the person to be notified based on the input name, input alias, input email address, and/or input badge identifier. The widget 3102 can include input fields for an expiry date for the trace. Selecting the date field launches a calendar 3104, allowing the user to select a date. If the user makes no selection, a default expiry date can be set (e.g., 30 days).

Referring now to FIG. 15, the interface 3100 displaying the badge trace home interface is shown when the user selects the “Trace” field to enter details, according to an exemplary embodiment. As the user type in the trace fields, a drop-down menu 3202 can appear listing possible matches to the typed data from an identity directory including names and badge numbers for employees of building site. The results show the name and badge number of the individuals and, where more than one badge number is assigned to an individual, all badge numbers 3204 assigned to them. Where no match is found between the information entered into the “Trace” field with the identity directory, a non-interactive cell appears indicating this and asking the user to change the badge to trace 3206.

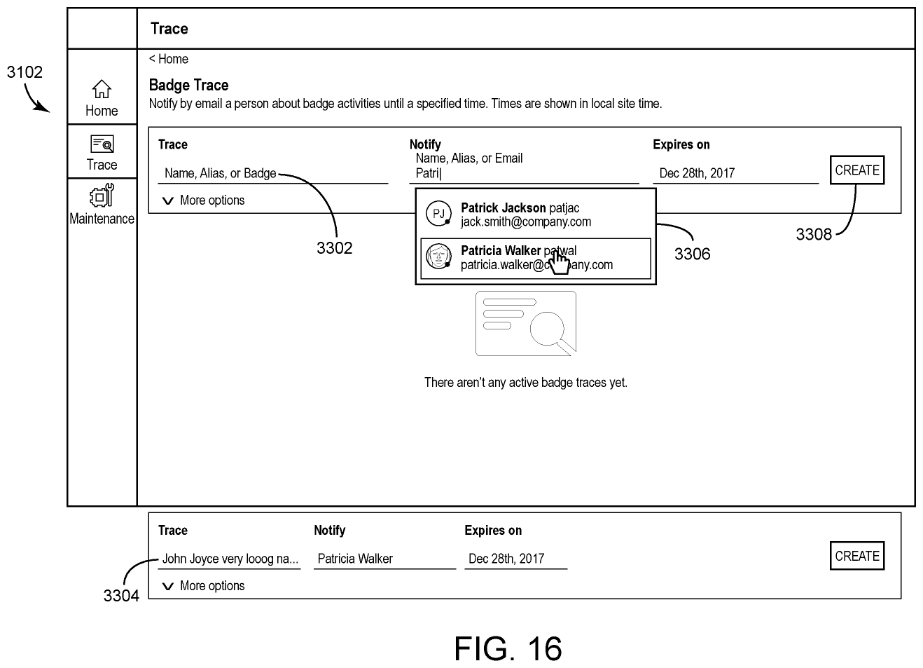

FIG. 16 shows the badge trace home interface 3100 following the selection by a user of the identity to be traced. Only name 3302 of the individual can be displayed, not the alias or badge number. If the name is too long to display, the name is truncated with an ellipsis 3304. The user starts typing the name of the person to be notified from the badge trace and a drop-down list 3306 of results is displayed as the name is typed. A trace cannot be created unless the “Trace” and “Notify” fields are completed, in some embodiments. Once the details are entered, the user clicks on the “CREATE” button 3308.

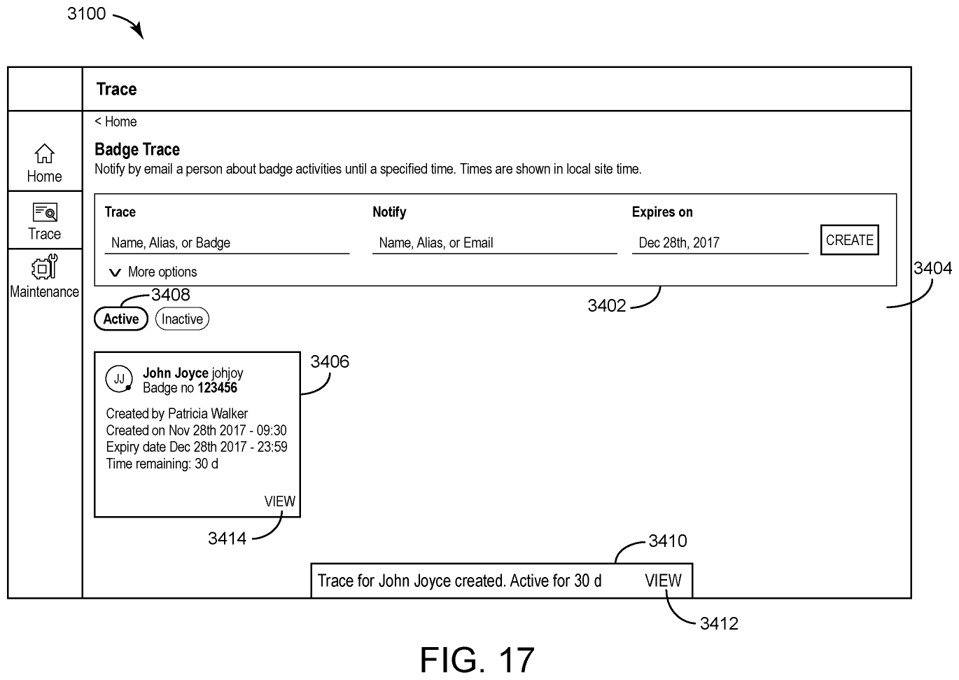

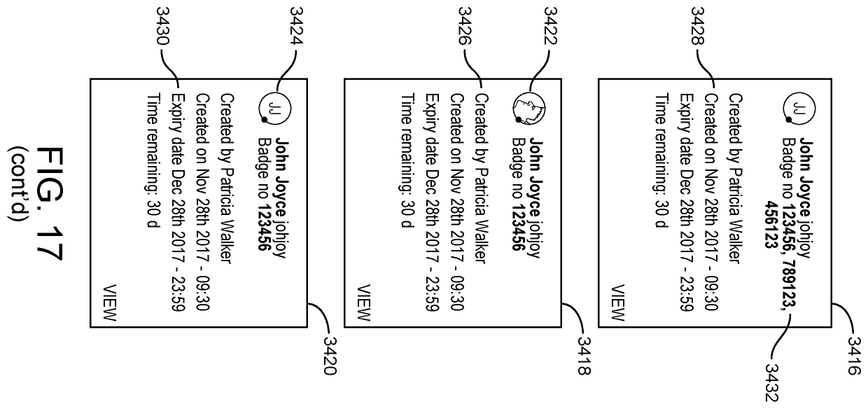

FIG. 17 shows the badge trace home interface 3100 following the creation of a new badge trace. The input fields 3402 have been reset. In the panel 3404 the newly created badge trace can be displayed as a card 3406 and tabs for “Active” and “Inactive” badge traces are displayed, with active badge trace cards displayed only in the “Active” tab 3408 and inactive badge trace cards displayed only in the “Inactive” tab 3409. By default, the “Active” tab 3108 is selected and the active traces displayed. A transient, self-dismissing message 3410 can be displayed, confirming the new badge trace, stating the name of the badge holder, the duration of the trace, and providing a “VIEW” option 3412 to view the details of the badge trace. The badge trace card 3406 can provides a “VIEW” option 3414, allowing the user to view the details of the trace.

Cards 3416, 3418, and 3420 show different examples of the badge trace card 3406 to illustrate various options. The card shows the name and alias of the badge holder, and an icon with their profile picture 3422. Where no picture is available from the system directory, the icon is the initials of the name of the person and surname 3424. The card also displays the name 3426 of the person who created the trace, the time of creation, converted to the local time 3428 of a user interacting with the interface 3100, and the expiry date of the trace, converted to a local time 3430 of the user. Where a traced individual has been assigned multiple badges, all badges 3432 are displayed.

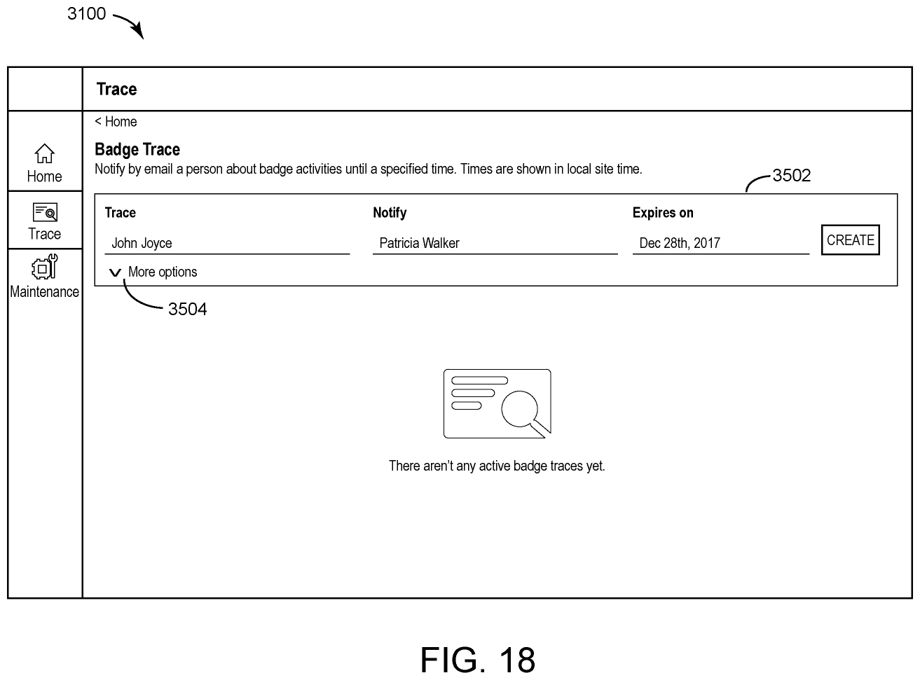

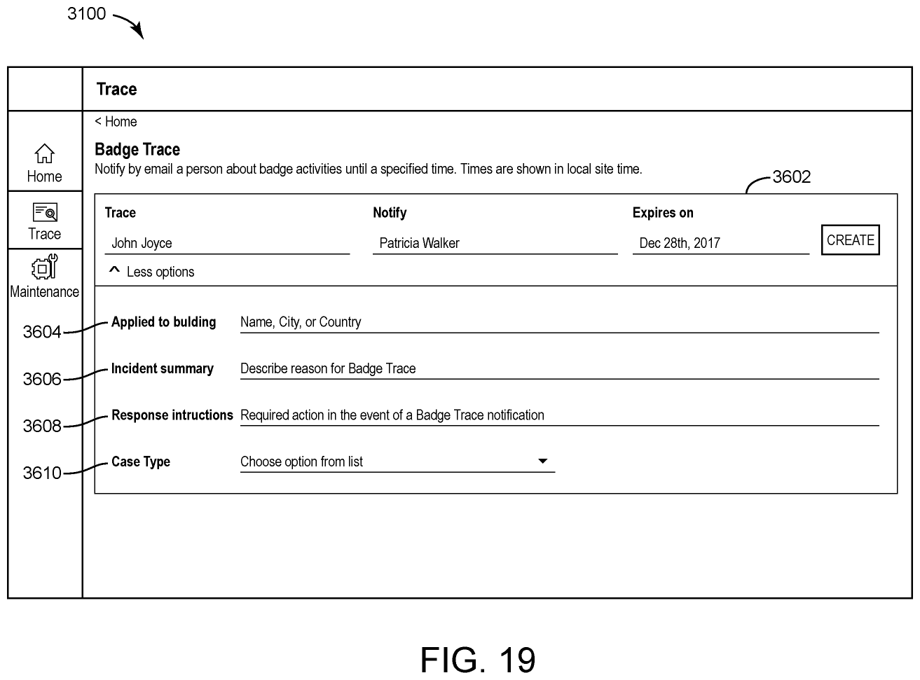

Referring now to FIGS. 18-22 the interface 3100 is shown where a user creates a new badge trace with additional options, according to various exemplary embodiments. FIG. 18 again shows the badge trace home interface 3100, where the user selects the “More options” element 3504 in the badge trace widget 3502. FIG. 19 shows the badge trace widget 3602, now expanded, and displaying various additional options. In response to an interaction with the “Applied to Building” field 3604, the POI system 210 is configured to search databases of buildings to match the input string, in some embodiments. In the “Incident summary” and “Response instructions” fields 3606 and 3608, a simple text input can be required. In the “Case Type” field 3610, the user is given a drop-down list of types, for example, threat of violence, security assisted termination, harassment, theft, or missing person.

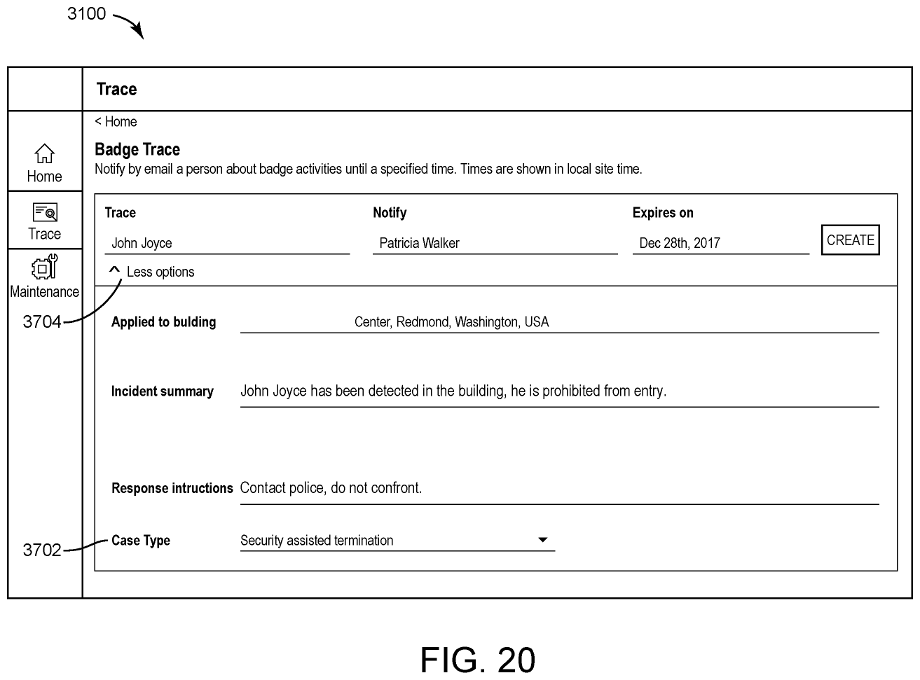

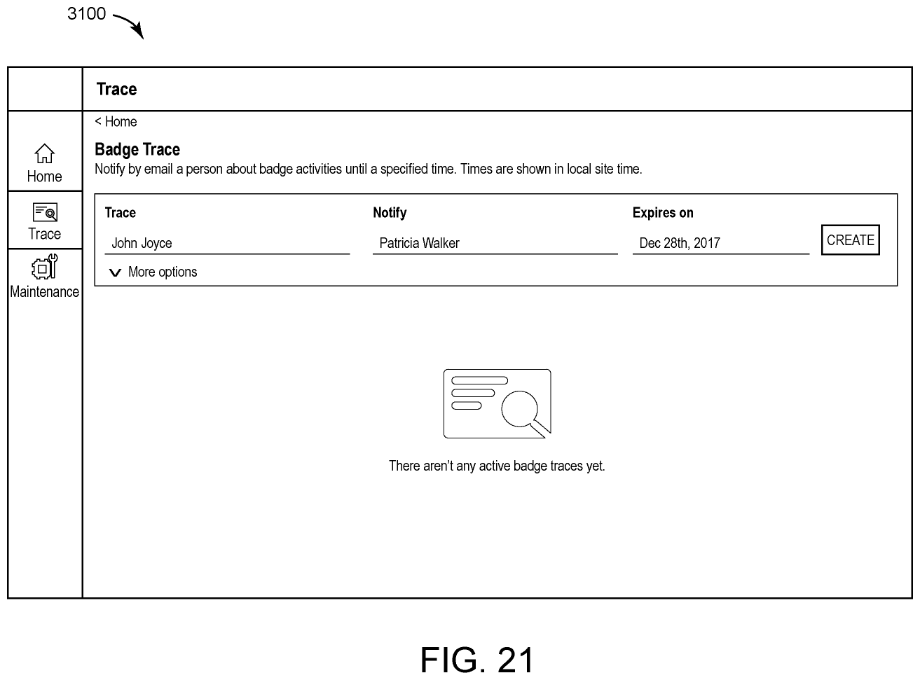

FIG. 20 shows the expended badge trace widget, now populated with content and a “Case Type” selection 3702 has been made. When the user selects the “Less options” element 3704, the widget returns to its unexpanded form in FIG. 21. Any additional optional information can be display in the unexpanded card.

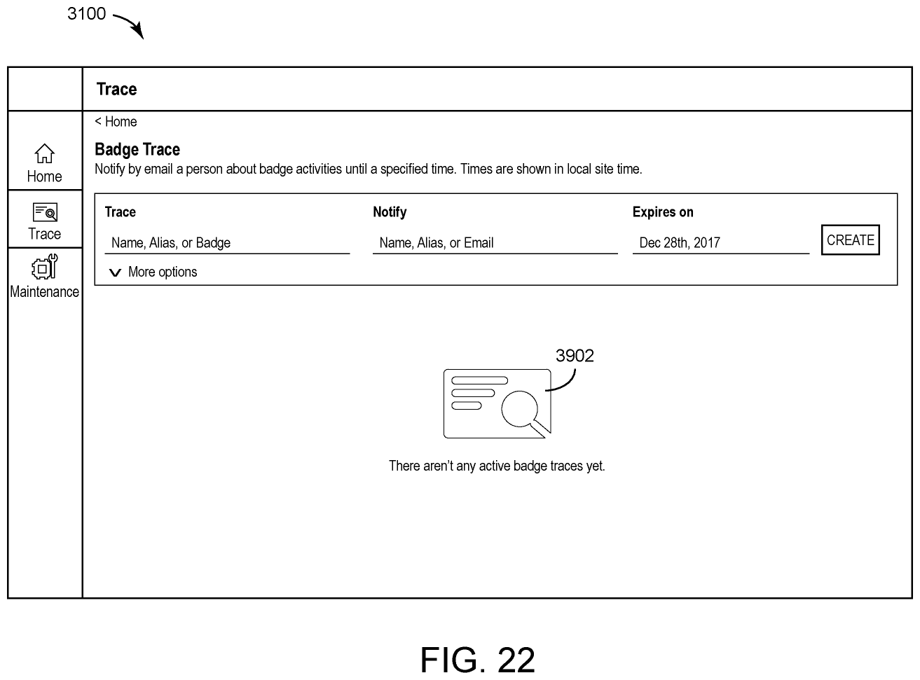

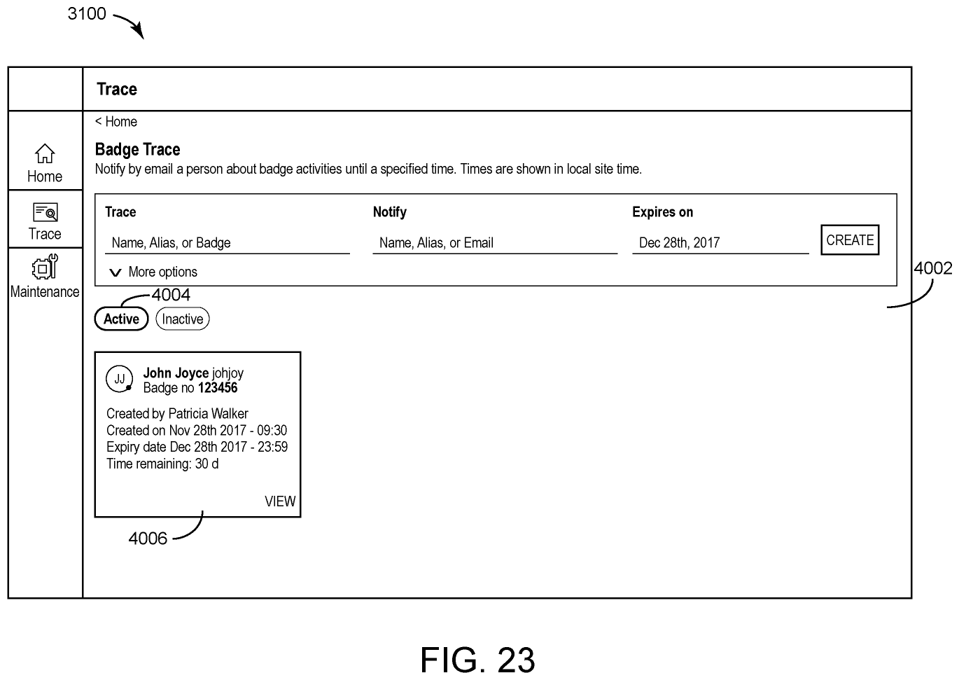

Referring now to FIGS. 22-25, active and inactive badge trace tabs of the interface 3100 are shown, according to an exemplary embodiment. FIG. 22 shows the badge trace home interface 3100 when there are no active traces in place. Inactive traces are not shown. Instead, there is a visual element 3902 indicating that there are no active badge traces. FIG. 23 shows the badge trace home interface 3100 when an active trace is in place. The panel 4002 below displays both the “Active” and “Inactive” tabs 4004, the “Active” tab is selected by default and shows a badge trace card 4006.

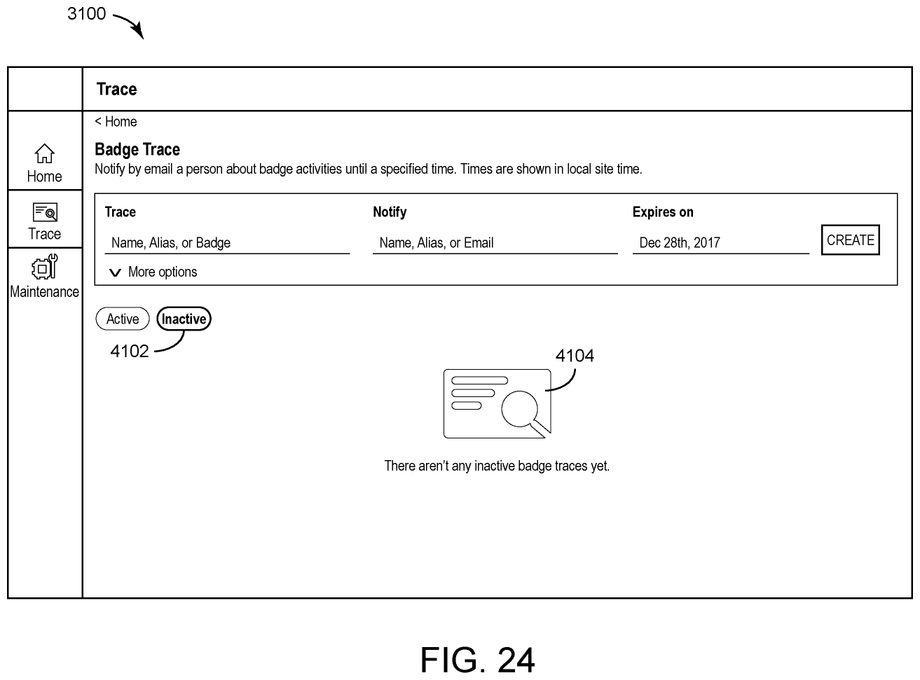

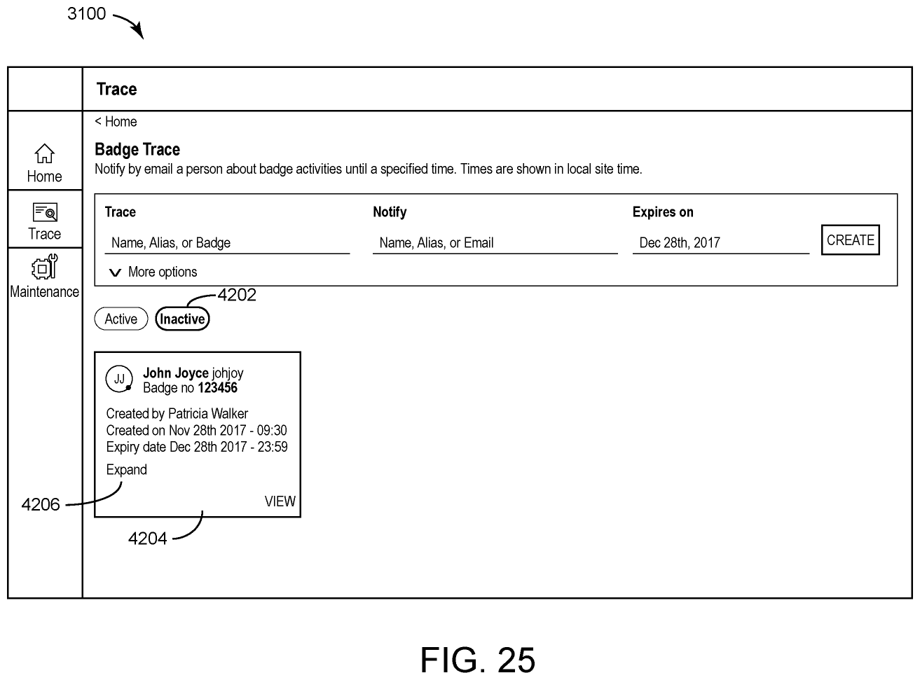

FIG. 24 shows the badge trace home interface 3100 when the user has selected the “Inactive” tab 4102. A visual element 4104 indicates that there are no inactive badge traces in place. FIG. 25 shows the badge trace home interface 3100 when the user has selected the “Inactive” tab 4202. In this example, there is an inactive badge trace in place. This is displayed as a badge trace card 4204 that has expired. The expired badge trace card 4202 includes an “Expired” indicator 4200.

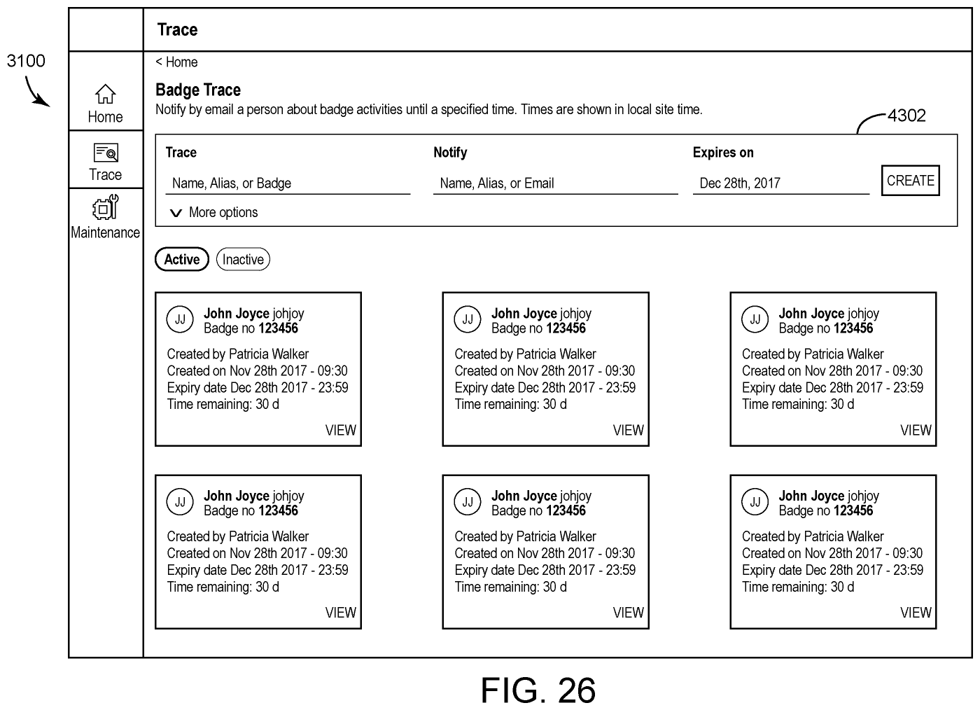

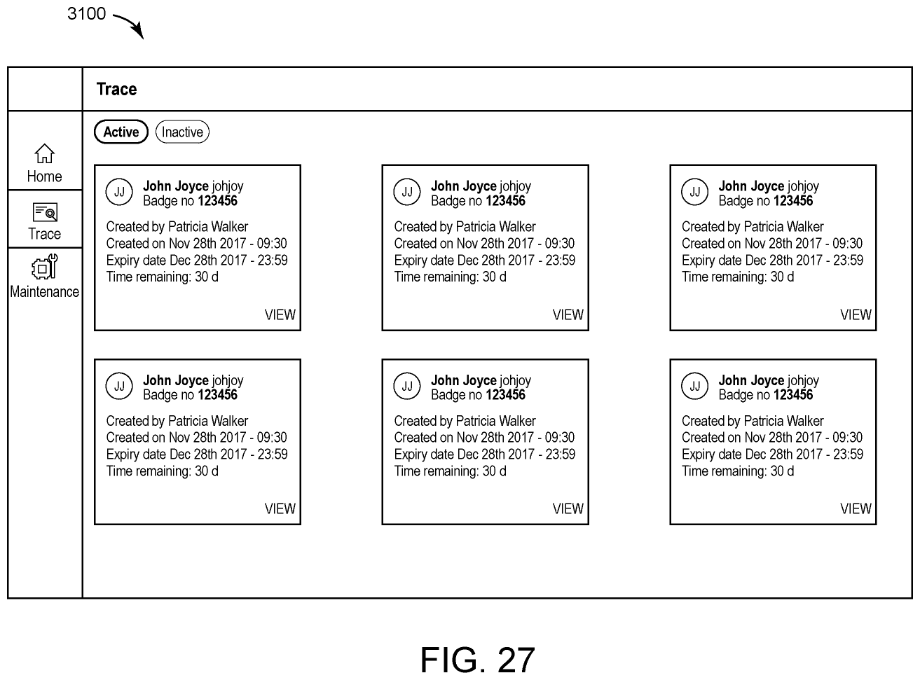

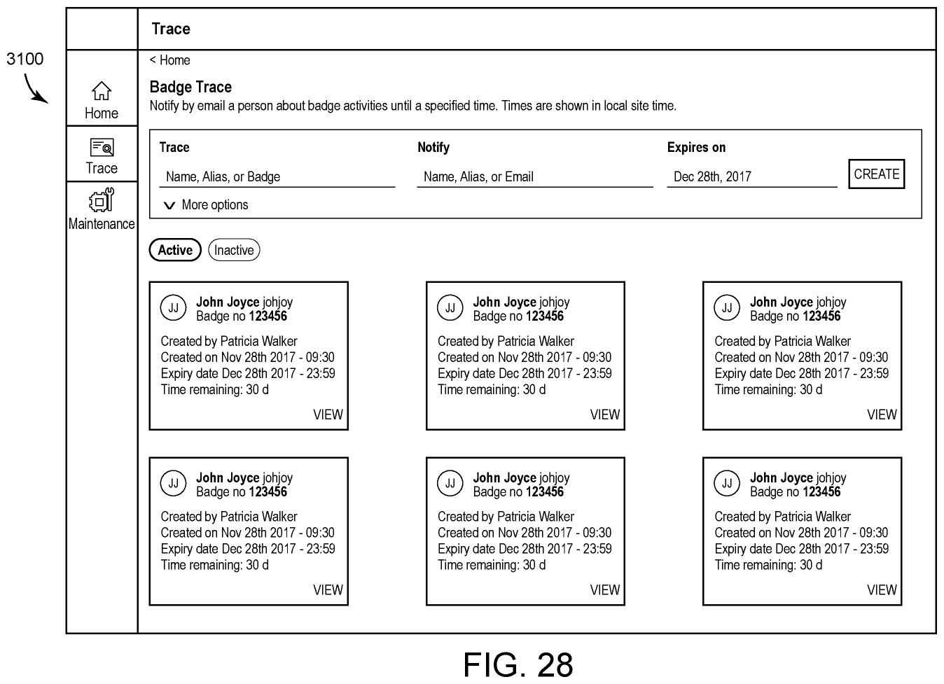

Referring now to FIGS. 26-30, user interaction with badge trace home interface 3100 is illustrated, according to various exemplary embodiments. FIG. 26 shows the badge trace home interface 3100, with the “Active” tab selected and active badge trace cards displayed. When the user scrolls down, the top bar 4302 disappears, giving more screen space to allow the user to view more badge trace cards as shown in FIG. 27. When the user scrolls up, the top bar reappears as shown in FIG. 28.

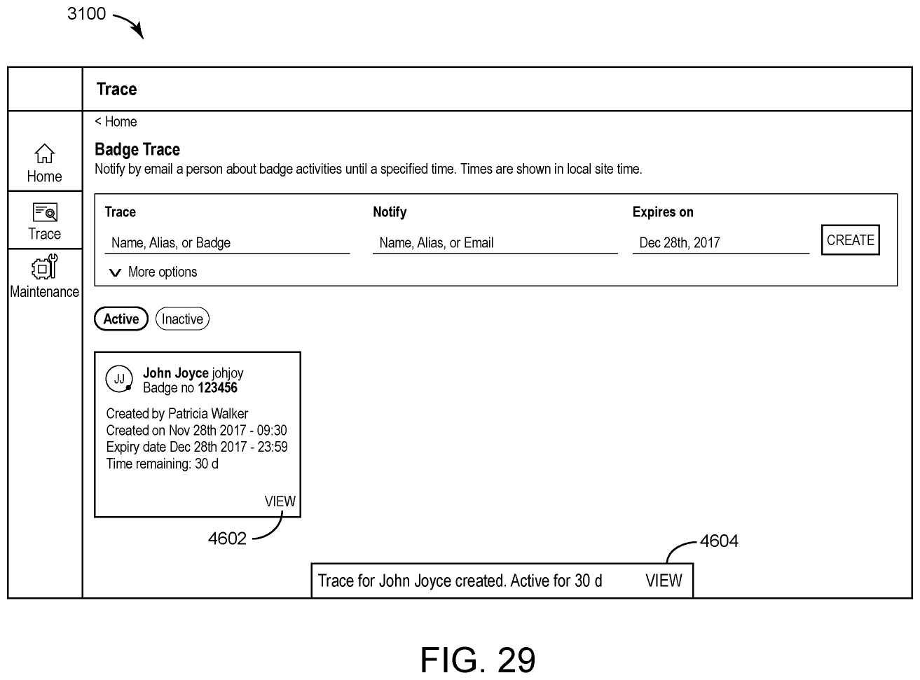

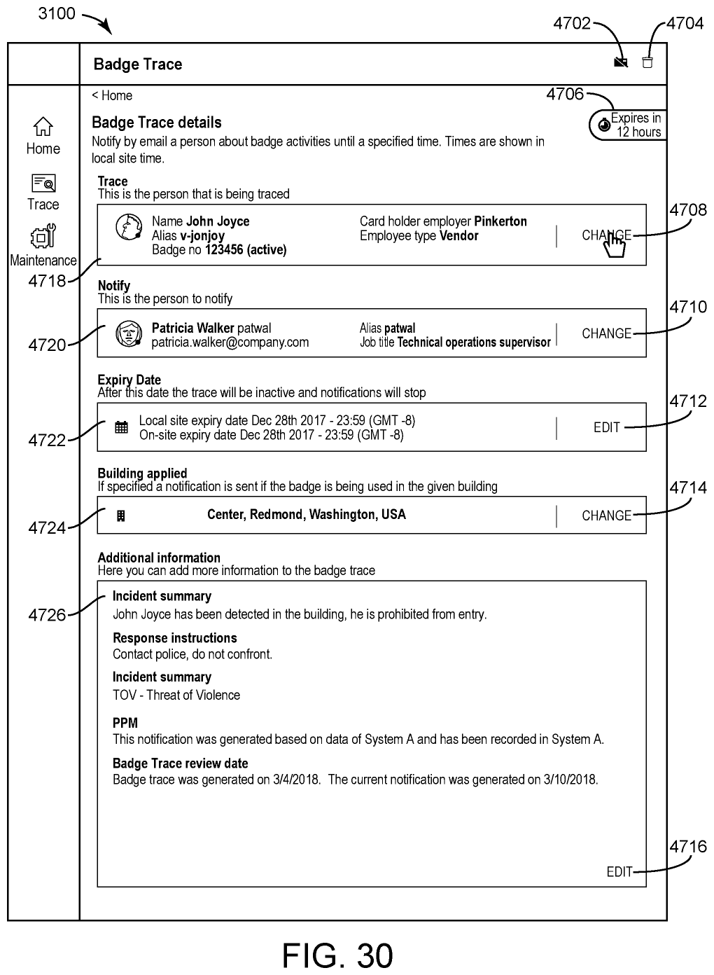

FIG. 29 shows the badge trace home interface 3100, following the creation of a new badge trace. The user can view the details of an individual badge trace by selecting the “VIEW” option 4602 from the badge trace card. The user may also view the same details by selecting the “VIEW” option from the transient self-dismissing notification 4604 while it is on screen. FIG. 30 shows the details of an individual badge trace. The user can select the inactive badge trace icon 4702 on the top of the screen to make the trace inactive and move it to the “Inactive” tab. If a badge trace is in the inactive tab, badge trace notifications will not be sent for the badge trace, in some embodiments. The delete icon 4704 can be disabled when the badge trace is currently active. The badge trace details page displays the time left until expiry of the trace 4706. The badge trace details page displays further information to the user, with options 4708-4716 to change or edit the information. The badge trace is separated into sections: the details of the person or badge traced 4718, the details of the person to notify 4720, the trace expiry date 4722, the details of any building, if applicable, for which notifications must be sent if the traced badge is used in that building 4724, and a section providing for additional information 4726, such as an incident summary, response instructions, case type, etc.

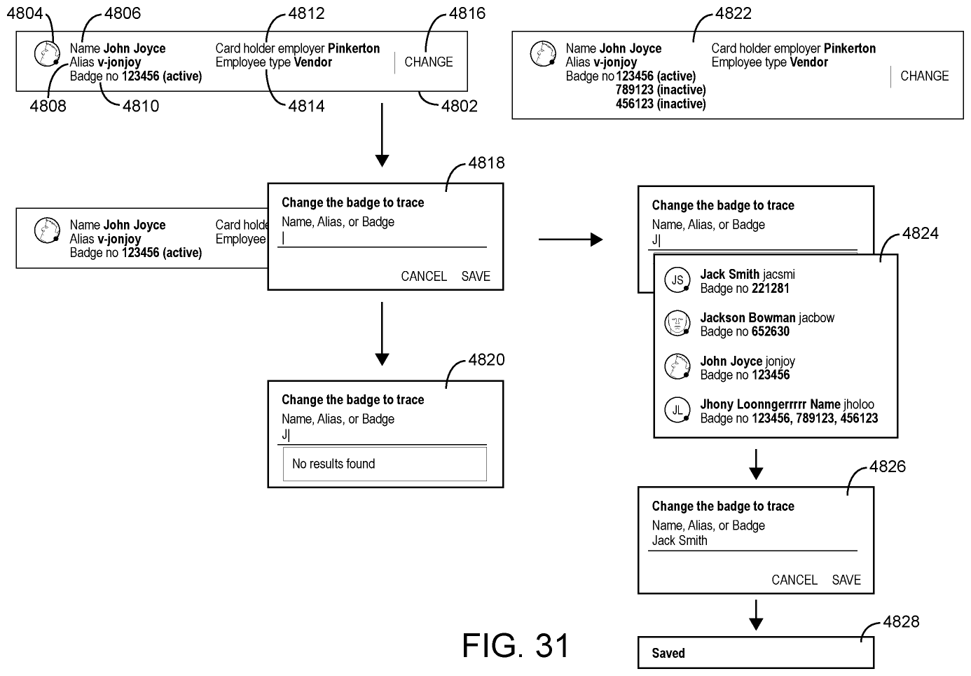

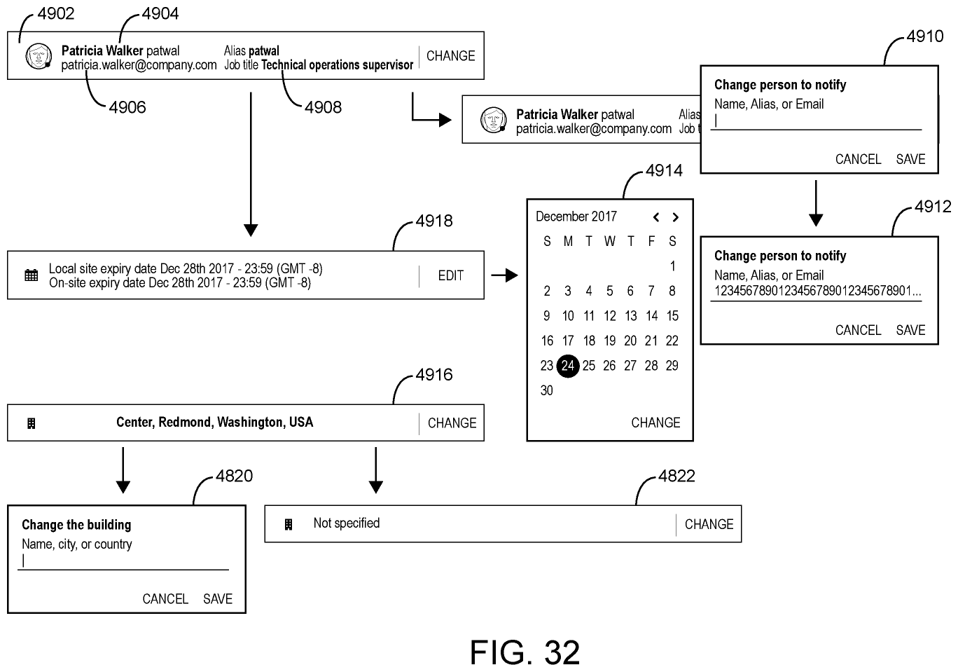

Referring now to FIGS. 31-35, accessing badge trace details interfaces from badge trace home interface 3100 is shown, according to various exemplary embodiments. FIG. 31 and FIG. 32 show, in more depth, some features of the sections forming part of the badge trace details page. FIG. 31 shows the “Trace” section in detail 4802. The section displays a picture 4804 of the person associated with the traced badge, if available, from the system directory, the person's name 4806, alias 4808, the badge number associated with that person 4810, the person's employer 4812, and employee type 4814. The section allows the user to change this information, using the “CHANGE” option 4816.

Where multiple badges are assigned to one person, all such badges will appear in the “Trace” section, showing their active or inactive status 4822. By selecting the “CHANGE” option, the user is presented with a window 4818, allowing them to change the name, alias, or badge number for the badge trace. Where no name, alias, or badge number is found in the system directory, a non-interactive cell displays 4820, indicating that no results were found can be displayed. As the user types in the input field, a drop-down list of possible matches is presented 4824. After the user selects a known name, alias, or email from the list 4826, the user may cancel or save the change. If saved, a transient, self-dismissing message 4828 can appear confirming that the change has been saved.

FIG. 32 shows the “Notify” section 4902 in detail. After selecting the “CHANGE” option, the user is presented with a window 4910, allowing them to change the person to notify by entering text in the field provided 4912. The procedure for making changes follows the same methodology as that for changing the identity of the badge trace (as described with reference to FIG. 31). The section displays the name of the person to be notified 4904, their work email address 4906, and their job title 4908.

The “Expiry date” section is shown in detail 4918. When the user selects the “EDIT” option, a window 4914 can appear, displaying a calendar for the user to select the expiry date of the trace, which must be a date in the future. The “Building applied” section is shown in detail in 4916. When the user selects the “CHANGE” option, a modal window 4920 appears, allowing the user to input a different building (or none). Where no building selection is made, the section displays as shown in 4922. The procedure for making changes follows the same methodology as that for changing the identity of the badge trace (as described with reference to FIG. 31).

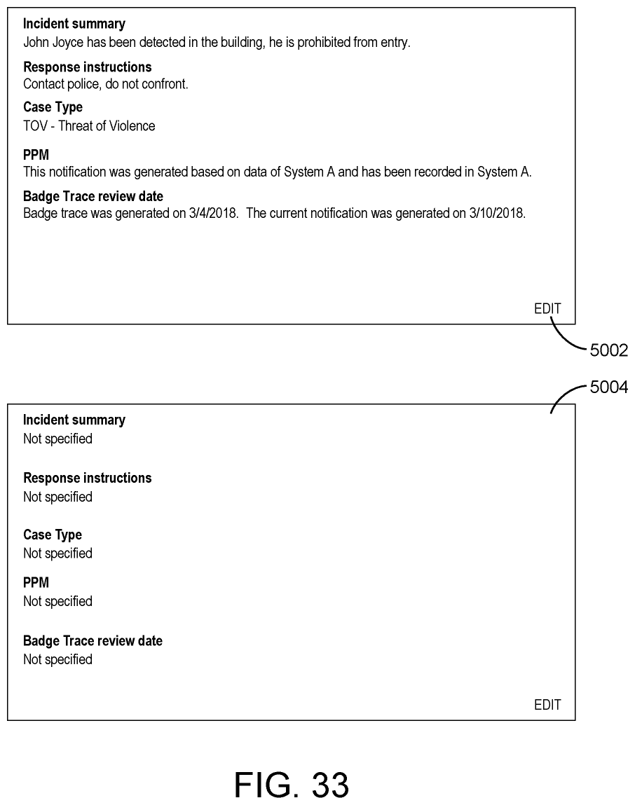

FIG. 33 shows the “Additional information” section in detail. The user may edit this section, using the “EDIT” option 5002. Except for the connection to other data sources (in this example, called ‘PPM’) and “Badge Trace review date” subsections, the information in this section is taken from the “Advanced options” screen when the user creates a new badge trace. Where this information was not created, the “Additional information” section appears as 5004.

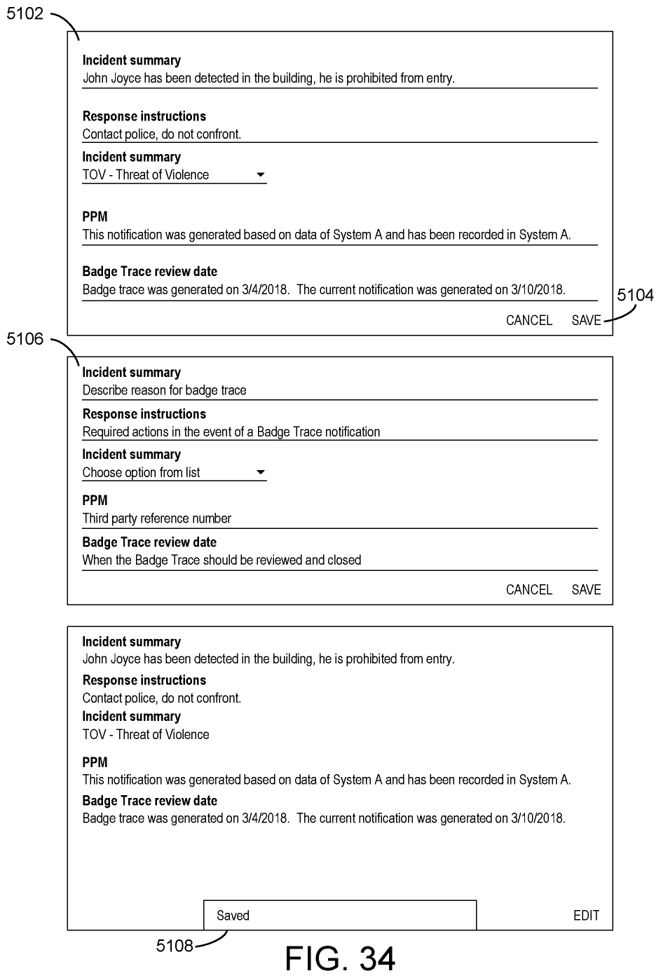

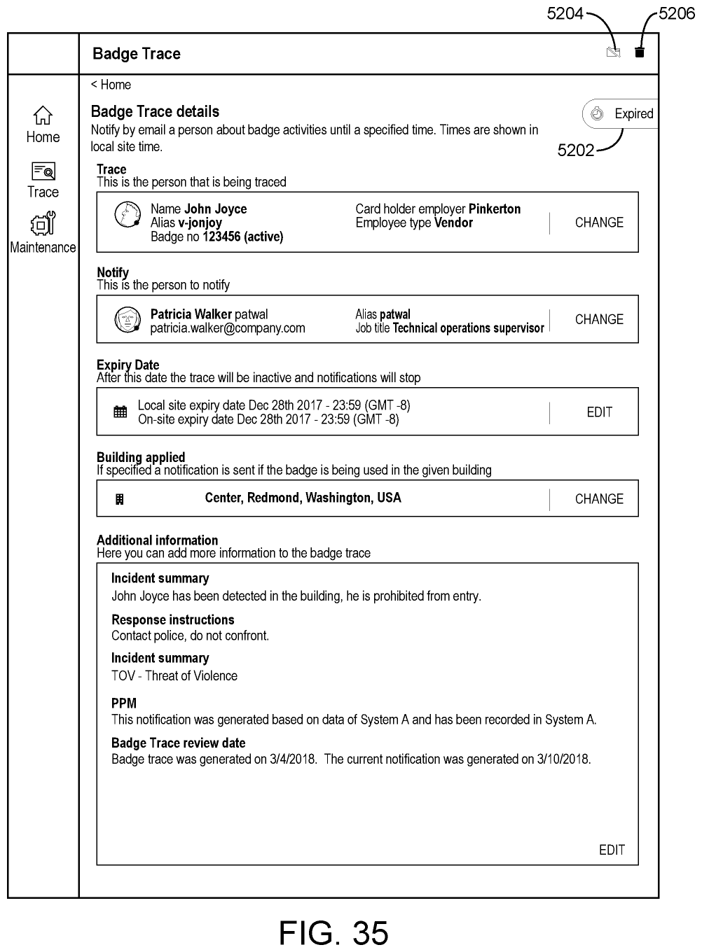

FIG. 34 shows the “Additional information” section in detail, when the user has selected the “Edit” option. Drawing 5102 shows the appearance of the section in edit mode when it contains information. The user may save or cancel any changes 5104. When the user saves the changes, the section displays the changes and a transient, self-dismissing notification appears confirming that the changes have been saved 5108. Where there was no content in the section, the appearance in edit mode looks like 5106. FIG. 35 shows the badge trace details page when a badge trace has expired. An indication is shown that it has expired 5202, the inactive option is disabled 5404, and the delete option is enabled 5106, which will allow the user to delete the badge trace from the system.

### Configuration of Exemplary Embodiments

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps and decision steps.

What is claimed is:

1. A method for a person of interest (POI) monitoring system, the method comprising:
generating a POI data structure, wherein the POI data structure comprises an identifier of an individual to be monitored as a POI;
causing the POI data structure to include an indication of one or more recipients to be notified upon detection of the individual;
receive, from a security device, security data that describes an interaction of the individual with the security device, the security data comprising the identifier of the individual;
determining whether the received identifier matches the identifier of the POI data structure; and
causing one or more user devices associated with the one or more recipients to display a GUI notification in response to the received identifier matching the identifier of the POI data structure.

2. The method of claim 1, wherein generating the POI data structure further comprises:
receiving, from a setup device, the POI data structure;
generating a POI identifier for the POI data structure;
receiving, from the setup device, POI information, POI tags, and POI restrictions; and
storing the POI data structure with the POI identifier, the POI information, the POI tags, and the POI restrictions.

3. The method of claim 1, wherein determining whether the received identifier matches the identifier of the POI data structure further comprises:
receiving, from the security device, a location and an identifier associated with a monitored individual;
searching a plurality of POI data structures with the identifier of the monitored individual;
verifying, based on the search, whether the monitored individual is a POI; and
determining, based on the location associated with the monitored individual, whether a POI alarm exists.

4. The method of claim 3, wherein each of the plurality of POI data structures further comprise one or more restricted areas and wherein the location is associated with the one or more restricted areas.

5. The method of claim 1, wherein the security data further comprises facial recognition data.

6. The method of claim 1, wherein the security data further comprises license plate recognition data.

7. The method of claim 1, wherein the GUI notification is an email message.

8. The method of claim 1, wherein the GUI notification is an alarm in an alarm interface.

9. The method of claim 1, wherein the POI data structure further comprises a response procedure describing one or more actions for the one or more recipients to take upon receiving the GUI notification.

10. The method of claim 1, wherein the security device is an access control device, and wherein the interaction of the individual with the security device includes the individual presenting an identifier (ID) card to the access control device.

11. A person of interest (POI) monitoring system, comprising:
a POI database storing a plurality of POI identifiers, each associated with an individual, wherein each of the POI identifiers is associated with one or more recipients to be notified upon detection of the individual;
a processing circuit having at least one processor and memory, the memory storing instructions thereon, that when executed by the at least one processor, cause the processing circuit to:
receive, from a security device, security data that describes an interaction of a monitored person with the security device, the security data comprising an identifier associated with the monitored person;
determine whether the received identifier matches any of the plurality of POI identifiers; and
in response to determining a match, cause one or more user devices associated with the one or more recipients associated with the matching POI identifier to display a GUI notification.

12. The POI monitoring system of claim 11, wherein the POI database is configured to:
receive, from a setup device, a POI data structure;
generate, a new POI identifier for the POI data structure;
receive, from the setup device, POI information, POI tags, and POI restrictions; and
store the POI data structure with the POI identifier, POI information, POI tags, and POI restrictions.

13. The POI monitoring system of claim 11, the memory further having instructions stored thereon, that when executed by the at least one processor cause, the processing circuit to:
receive, from the security device, a location associated with the monitored person; and
verify, based on the location, that a POI alarm exists.

14. The POI monitoring system of claim 13, wherein each of the POI identifiers in the POI database are further associated with one or more restricted areas, and wherein the location is associated with the one or more restricted areas.

15. The POI monitoring system of claim 11, wherein the security data further comprises facial recognition data.

16. The POI monitoring system of claim 11, wherein the security data further comprises license plate recognition data.

17. The POI monitoring system of claim 11, wherein the GUI notification is an email message.

18. The POI monitoring system of claim 11, wherein the GUI notification is an alarm in an alarm interface.

19. The POI monitoring system of claim 11, wherein each of the plurality of POI identifiers in the POI database are further associated with a response procedure describing one or more actions for the one or more recipients to take upon receiving the GUI notification.

20. The POI monitoring system of claim 11, wherein the security device is an access control device, and wherein the interaction of the monitored person with the security device includes the monitored person presenting an identifier (ID) card to the access control device.
